(19) United States
(12) Patent Application Publication
(10) Pub. No.: US 2015/0264519 A1
(43) Pub. Date: Sep. 17, 2015

(54) EFFICIENT GENERATION AND UPDATE OF HEAT MAPS

(71) Applicant: QUALCOMM Incorporated, San Diego, CA (US)

(72) Inventors: Faraz Mohammad Mirzaei, San Jose, CA (US); Saumitra Mohan Das, Santa Clara, CA (US); Kelvin So, Berkeley, CA (US); Ayman Fawzy Naguib, Cupertino, CA (US)

(73) Assignee: QUALCOMM Incorporated, San Diego, CA (US)

(21) Appl. No.: 14/210,140

(22) Filed: Mar. 13, 2014

(51) Int. Cl. H04W 4/02

(52) U.S. Cl. CPC H04W 4/02

(57) ABSTRACT

Methods and apparatuses are presented for generating and updating heat maps for terrestrial wireless transceivers located in an area or venue. According to some embodiments, a method may include obtaining, by a mobile device, first signal data for a terrestrial transceiver and generating, by the mobile device, a transceiver heat map using the first signal data. The method may further include displaying, by the mobile device, a request to gather additional signal data for the terrestrial transceiver and obtaining, by the mobile device, second signal data for the terrestrial transceiver. The method may further include generating, by the mobile device, an updated transceiver heat map using the second signal data and displaying, by the mobile device, the updated transceiver heat map.

### FIELD

The present disclosure relates to generation of heat maps. Specifically, various techniques and systems are provided for efficiently generating and updating heat maps for terrestrial wireless transceivers located in an area or venue.

### BACKGROUND

Location determination techniques enable the current location, and optionally the speed and heading, of a mobile wireless device to be obtained. The determined location may then be provided to the wireless device (e.g., to an application running on the wireless device or to the user of the wireless device) or to some external third party. A number of software applications, websites, and other functionalities that can be provided on or to a mobile device may use the location information for location-based services that further enhance a user's experience when using such a device. For example, a device may access a particular website, such as a restaurant review website, and the website may use information about the device's current location in order to provide location-specific content, such as reviews of nearby restaurants, to the device. Other applications and/or websites may, for instance, use information about a device's current location to display relevant maps to a user, provide the user with information about local businesses, provide navigation directions, or inform the user of a local weather forecast or local traffic conditions. Certain applications and websites may be dedicated to providing location related content for indoor use, such as walking directions to reach a particular gate in an airport, particular store in a shopping mall or particular room in an office building. These applications and websites may rely on accurate location information for a mobile device in order to reliably provide such location content in an environment where small changes in location may have significant consequences for location related content.

Venue surveys may be conducted to provide indoor positioning data for multi-tenant venues. For example, a technician may take measurements of terrestrial wireless transceiver signals located throughout the venue in order to provide data for generating one or more heat maps. The heat maps may then be used to determine a location of one or more mobile devices. Performing venue surveys accurately in large venues, such as malls, may be difficult. For example, heat maps are typically generated by server-based tools using the measurements taken by the technician, which may include thousands of measurements. The vast amount of measurements may cause the server to take hours or even days to generate the heat maps. As a result, data collection feedback may not be provided to the technician in time to be useful, which may lead to multiple survey visits and increased cost.

### BRIEF SUMMARY

Various techniques and systems are provided for efficiently generating and updating heat maps for terrestrial wireless transceivers located in an area or venue. In some embodiments, a heat map generation or updating system, method, or computer readable media may be provided to generate immediate feedback on signal and/or position information within a venue. For example, a technician application running on a mobile device may receive signal data measurements from one or more terrestrial wireless transceivers in the venue. The technician application, or a server application running on a remote server, may generate one or more heat maps using the signal data measurements and may use the one or more heat maps to determine position information related to a location of the device within the venue. Based on errors in the positioning information detected by the technician or server application, feedback may be provided to the technician through the device indicating that more measurements should be taken in certain areas of the venue. The technician or server application may generate one or more updated heat maps using the additional measurements and may use the one or more updated heat maps to determine updated position information. The feedback may be provided to the technician until one or more updated heat maps are generated that allow a determination of sufficiently accurate positioning information. Once the positioning information determined using the one or more heat maps becomes sufficiently accurate, the technician can move on to collecting measurements in another part of the venue.

In some embodiments, a heat map generation or updating system, method, or computer readable media may be provided for reducing the computational time for generating or updating a heat map. For example, a user or technician may specify an allotted or maximum time for generating a heat map for a terrestrial wireless transceiver. The system, method, or computer readable media may subsample signal data measurements of the terrestrial wireless transceiver and/or may reduce the dimension of a feasible point grid that is used in an interpolation process in order to generate the heat map within the allotted time. Accordingly, intelligent techniques may be provided for subsampling the measurements and/or reducing the feasible points without compromising the accuracy of the constructed heat map. In some embodiments, a comparison may be made between the allotted time and an estimated time for generating the heat map, and the measurements may be subsampled and/or the feasible points may be reduced if the comparison indicates that the estimated time will exceed the allotted time. As a result, heat maps may be generated in a short enough amount of time (e.g., on a scale of seconds or minutes) so that feedback information can be provided to a technician quickly enough to allow the technician to finish a venue survey without conducting multiple survey visits.

According to at least one example, a method of updating heat map data is provided. The method may include obtaining first signal data for a terrestrial transceiver and generating a transceiver heat map using the first signal data. The method may further include displaying a request to gather additional signal data for the terrestrial transceiver, obtaining second signal data for the terrestrial transceiver, and generating an updated transceiver heat map using the second signal data. The method may further include displaying the updated transceiver heat map. The method may be performed by a mobile device, an application executed by the mobile device, and/or the like.

In some embodiments, an apparatus is provided that comprises a memory and a receiver configured to receive first signal data for a terrestrial transceiver. The apparatus may further comprise one or more processors configured to generate a transceiver heat map using the first signal data, and a display configured to display a request to gather additional signal data for the terrestrial transceiver. The receiver is configured to receive second signal data for the terrestrial transceiver, and the display is configured to display an updated transceiver heat map using the second signal data.

In some embodiments, one or more non-transitory computer-readable media storing computer-executable code executable on one or more computing devices included in a mobile device are provided. The one or more non-transitory computer-readable media may comprise code to obtain first signal data for a terrestrial transceiver, and code to generate a transceiver heat map using the first signal data. The one or more non-transitory computer-readable media may further comprise code to display a request to gather additional signal data for the terrestrial transceiver, code to obtain second signal data for the terrestrial transceiver, code to generate an updated transceiver heat map using the second signal data, and code to display the updated transceiver heat map

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

A further understanding of the nature and advantages of various embodiments may be realized by reference to the following figures.

FIG. 1 is an illustration of an example of a wireless network environment with a terrestrial wireless transceiver and mobile devices, according to some embodiments.

FIG. 2 is an overhead perspective view of an example of a venue with one or more terrestrial wireless transceivers, according to some embodiments.

FIG. 3 is an example of a grid of feasible points within a venue, according to some embodiments.

FIG. 4 is an example of a heat map, according to some embodiments.

FIG. 5 is a flowchart illustrating an example of a process for creating or updating heat map data, according to some embodiments.

FIG. 6 is a flowchart illustrating an example of a process for obtaining heat map data, according to some embodiments.

FIGS. 7A-E illustrates techniques for reducing a number of feasible points used to generate a heat map, according to some embodiments.

FIG. 8 is a flowchart illustrating an example of a process for reducing a number of measurements used to generate a heat map, according to some embodiments.

FIG. 9 is a graph illustrating a number of measurements per amount of runtime, according to some embodiments.

FIG. 10 is a graph illustrating results of reducing a number of measurements used to generate a heat map, according to some embodiments.

FIG. 11 is a graph illustrating position accuracy resulting from reduction of a number of measurements used to generate a heat map, according to some embodiments.

FIG. 12 is a block diagram illustrating an example of a mobile device according to some embodiments.

FIG. 13 is a block diagram illustrating an example of a terrestrial wireless transceiver according to some embodiments.

FIG. 14 is a block diagram illustrating an example of a location server according to some embodiments.

### DETAILED DESCRIPTION

In the following description, for the purposes of explanation, specific details are set forth in order to provide a thorough understanding of embodiments of the invention. However, it will be apparent that various embodiments may be practiced without these specific details. The figures and description are not intended to be restrictive.

Apparatuses, methods, systems, and computer-readable media for efficiently generating and updating heat maps for terrestrial wireless transceivers are presented. As used herein, a “terrestrial transceiver” or “terrestrial wireless transceiver” may refer to any ground-stationed or terrestrial based device configured to transmit information about its location to a client device (e.g. a mobile device). The information pertaining to a terrestrial wireless transceiver location may include, for example, ranging measurements obtained by the client device, relative to the terrestrial wireless transceiver. Ranging measurements of terrestrial wireless transceivers may include, for example, received signal strength indicator (RSSI) measurements, round trip time (RTT) measurements, 2-dimensional or 3-dimensional coordinates, or other types of formats known to those with skill in the art. Non-limiting examples of terrestrial wireless transceivers include access points, femtocells, base stations, picocells, macrocells, Zigbee™ transceivers, and Bluetooth™ transceivers. Femtocells may be thought of as small base stations, sometimes known as home base stations or small cells, that support a small coverage area such as a home, office, or part of a building or venue. In some embodiments, femtocells may be installed by users and not by a network operator. Further details about terrestrial wireless transceivers will be discussed below.

The techniques described herein may be used for mobile device or client access to various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” may be used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95, IS-856 and High Rate Packet Data (HRPD) standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA is part of Universal Mobile Telecommunication System (UMTS). Long Term Evolution (LTE) is a radio access technology used by E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). IEEE 802.11 networks are also known as WiFi networks or wireless local area networks (WLANs) and are defined in a family of standards from the Institute of Electrical and Electronics Engineers (IEEE). These various radio technologies and standards are known in the art.

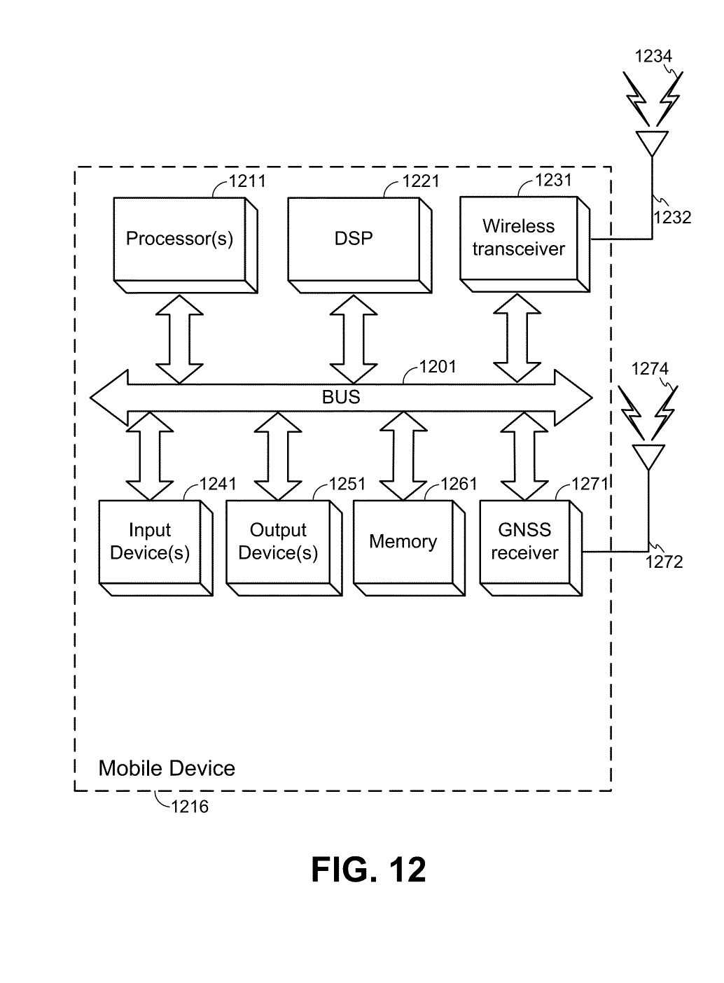

Various embodiments are described herein in connection with a mobile device, such as mobile device 1216 described below with respect to FIG. 12. A mobile device can also be called a system, subscriber unit, subscriber station, mobile station, mobile, remote station, remote terminal, mobile device, user terminal, terminal, mobile terminal, wireless device, wireless terminal, wireless communication device, user agent, user device, computing device, Secure User Plane (SUPL) Enabled Terminal (SET) or user equipment (UE). A mobile device or SET can be a cellular telephone, a cordless telephone, a smartphone, a Session Initiation Protocol (SIP) phone, a wireless local loop (WLL) station, a personal digital assistant (PDA), a handheld device having wireless connection capability, a computing device, a laptop, a tablet or other processing device connected to or containing a modem, for example, a wireless modem.

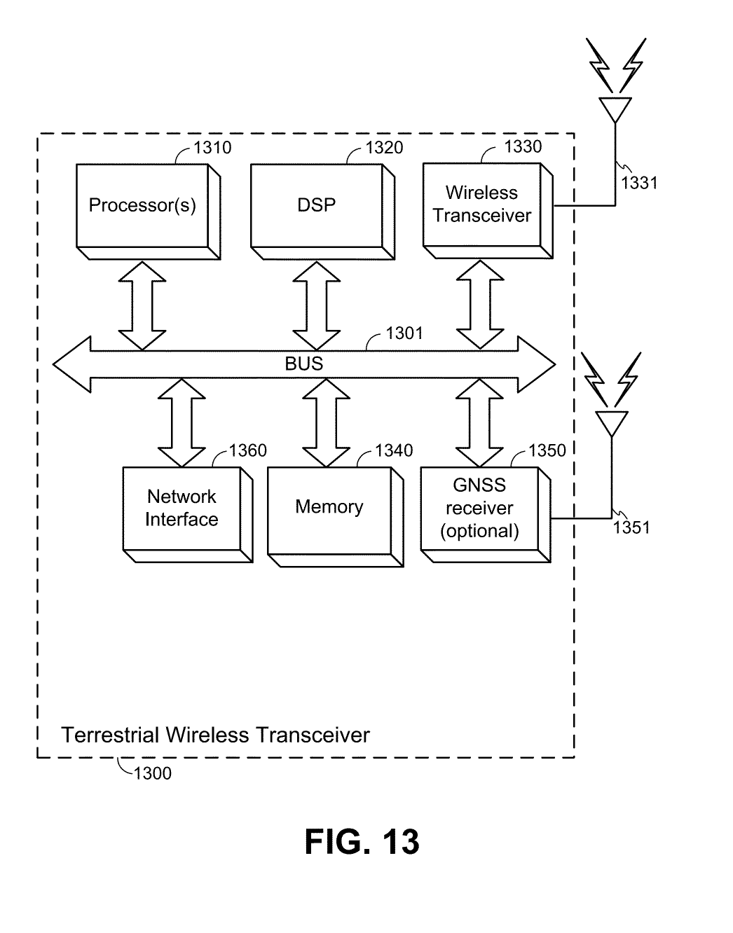

Moreover, various embodiments are described herein in connection with a terrestrial wireless transceiver, such as terrestrial wireless transceiver 1300 described below with respect to FIG. 13. A terrestrial wireless transceiver can be utilized for communicating with mobile device(s) via radio signals in order to provide communication, location and/or other services to mobile devices and can also be referred to as a base station, access point, Node B, Evolved Node B (eNodeB), access point base station, a WiFi, an access point, a Femtocell, home base station, home Node B, home eNodeB, or some other terminology.

Aspects of the disclosure relate to generating and updating heat maps that may be used for location determination for mobile devices. Venue surveys may be conducted to provide indoor positioning data that can be used to generate and/or update heat maps for terrestrial wireless transceivers located within a venue. While conducting a venue survey, a user (e.g., a technician, a surveyor, or the like) may obtain signal data measurements of one or more of the terrestrial wireless transceivers located throughout the venue. The signal data may be used to generate one or more heat maps that may then be used to determine a location of one or more mobile devices. Performing venue surveys accurately in large venues, such as malls, may be difficult. For example, the signal data measurements may include a large number of measurements. Given the large amount of measurements, the server-based tools that are generally used for heat map generation may take hours or even days to generate the heat maps. As a result of the delay in heat map generation, it may not be possible to provide data collection feedback to the user in time so that the user can obtain additional signal data for updating the heat maps to provide more accurate location determination.

Various techniques and systems are provided for efficiently generating and updating heat maps for terrestrial wireless transceivers located in an area or venue. For example, a heat map generation or updating system, method, or computer readable media may be provided to quickly generate feedback on signal and/or position information within a venue. In some embodiments, a technician application running on a mobile device may receive signal data measurements from one or more terrestrial wireless transceivers in the venue. One or more heat maps may be generated using the signal data measurements. For example, the technician application or a server application running on a remote server may be used to generate the one or more heat maps. The technician application or server application may determine position information related to a location of the device within the venue using the one or more heat maps. The technician application or server application may then detect errors in the positioning information, and may provide feedback to the technician through the device indicating that more measurements should be taken in certain areas of the venue. For example, the feedback may be provided through a display of the mobile device (e.g., a color coded map), through one or more indicators on the mobile device (e.g., color coded lights), through a speaker of the mobile device as an audio signal, through haptic actuators such as vibration, and/or the like. The technician or server application may generate one or more updated heat maps using the additional measurements and may determine updated position information using the one or more updated heat maps. The technician may be provided with feedback to gather additional measurements until one or more updated heat maps are generated that allow a determination of sufficiently accurate positioning information for the mobile device. The technician may continue collecting measurements in another part of the venue once the positioning information determined using the one or more heat maps becomes sufficiently accurate.

In some embodiments, a heat map generation or updating system, method, or computer readable media may also be provided for reducing the computational time for generating and/or updating heat maps. For example, a user (e.g., a technician, a surveyor, or the like) may specify an allotted or maximum time for generating one or more heat maps for a terrestrial wireless transceiver. Various techniques may be used to generate the one or more heat maps within the allotted time. As one example, signal data measurements of the terrestrial wireless transceiver may be subsampled in order to reduce the amount of measurements used in generating the one or more heat maps. As another example, the amount of feasible points that are used in the interpolation process to generate the one or more heat maps may be reduced. Accordingly, intelligent techniques may be provided for subsampling the measurements and/or reducing the feasible points without compromising the accuracy of the constructed heat map. In some embodiments, a comparison may be made between the allotted time and an estimated time for generating the heat map, and the measurements may be subsampled and/or the feasible points may be reduced if the comparison indicates that the estimated time will exceed the allotted time. As a result, heat maps may be generated in a short enough amount of time (e.g., on a scale of seconds or minutes) so that feedback information can be provided to the user quickly enough for the user to conduct the venue survey in a single visit.

These descriptions and others will be discussed in more detail in relation to the figures discussed below.

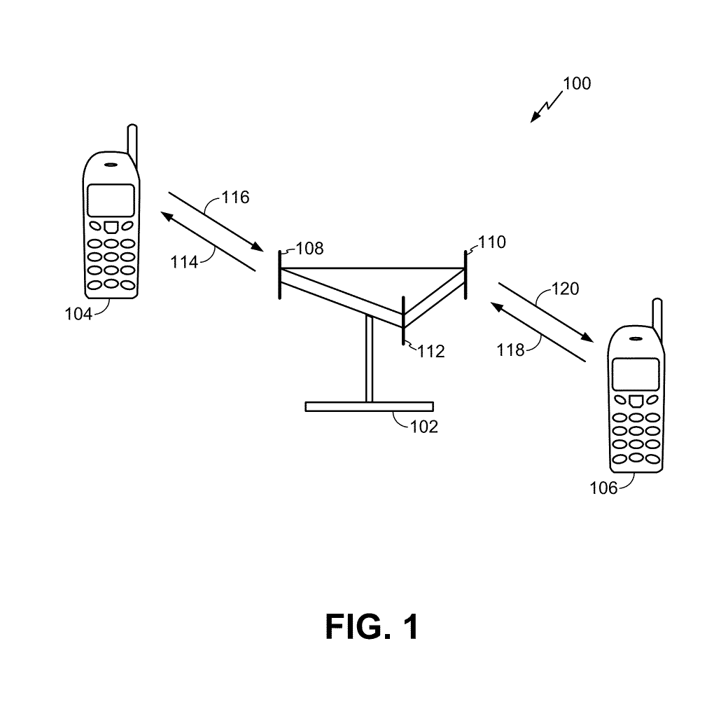

Referring to FIG. 1, an example of a wireless network environment 100 including a terrestrial wireless transceiver 102 and mobile devices 104 and 106 is presented. Mobile devices 104 and 106 may include, for example, the mobile device 1216 described below with respect to FIG. 12. Terrestrial wireless transceiver 102 may include, for example, the terrestrial wireless transceiver 1300 described below with respect to FIG. 13. Terrestrial wireless transceiver 102 includes multiple antennas, including 108, 110, and 112. More or fewer antennas may be utilized in other embodiments. Mobile device 104 may be in communication with terrestrial wireless transceiver 102 via antenna 108, where antenna 108 may transmit signals to mobile device 104 over forward link 114 and may receive signals from mobile device 104 over reverse link 116. Mobile device 106 is in communication with terrestrial wireless transceiver 102 via antenna 110, where antenna 110 may transmit signals to mobile device 106 over forward link 120 and may receive signals from mobile device 106 over reverse link 118. In a Frequency Division Duplex (FDD) system, communication links 114, 116, 118, and 120 may use different frequencies for communication. For example, forward link 114 may use a different frequency then that used by reverse link 116. In some embodiments, antennas 108, 110, and 112 may each be in communication with both mobile devices 104 and 106. Mobile device 104 may be in communication with terrestrial wireless transceiver 102 in a first frequency, while mobile device 106 may be in communication with terrestrial wireless transceiver 102 in a second frequency, for example. In some embodiments, multiple antennas, e.g. antennas 108 and 110, may be in communication with a single mobile device, e.g. mobile device 104. In some embodiments, multiple antennas may be used to transmit the same type of data but arranged in different sequences to improve diversity gain.

The system in FIG. 1 may support operation on multiple carriers (waveform signals of different frequencies). Multi-carrier transmitters can transmit modulated signals simultaneously on the multiple carriers. The signal may follow one or more standards, such as a CDMA signal, a TDMA signal, an OFDMA signal, a SC-FDMA signal, a LTE signal, a WiFi signal, or the like. Each modulated signal may be sent on a different carrier and may carry pilot data, overhead information, payload data, or the like.

While communicating over forward links 114 and 120, the transmitting antennas of terrestrial wireless transceiver 102 may utilize beamforming in order to improve the signal-to-noise ratio of forward links for the different mobile devices 104 and 106. Also, a terrestrial wireless transceiver using beamforming to transmit to mobile devices scattered randomly throughout its coverage area causes less interference to mobile devices in neighboring coverage areas of other terrestrial wireless transceivers than a terrestrial wireless transceiver transmitting through a single antenna to all mobile devices in its coverage area.

Various types of terrestrial wireless transceivers or transmitting stations may be employed. For example, terrestrial wireless transceiver 102 may be a base station, a femtocell, or an access point. In some embodiments, the terrestrial wireless transceiver 102 may provide access to a first network while a second terrestrial wireless transceiver, such as a cellular base station, may provide access to a second network. In some embodiments, mobile devices 104 and/or 106 may be in communication with one type of terrestrial wireless transceiver (e.g., transceiver 102), which may be in communication with an additional terrestrial wireless transceiver of another or the same type, which may then be in communication with a network (e.g., the Internet, a CDMA network, a TDMA network, a FDMA network, an OFDMA network, a SC-FDMA network, or the like), and so forth. In some embodiments, terrestrial wireless transceiver 102 may be the same or different type than other terrestrial wireless transceivers that may be within the wireless network environment 100 (e.g. one may be an access point, while the other may be a base station). In some embodiments, the areas that may be accessed using each of the terrestrial wireless transceivers within the wireless network environment 100 may overlap.

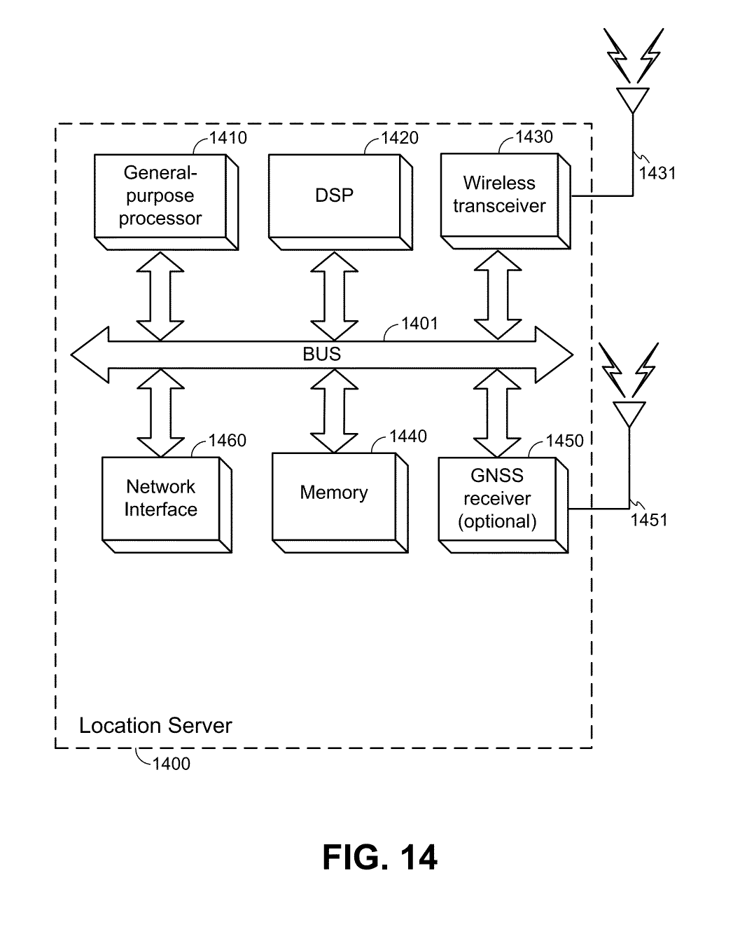

In some embodiments, a location server (not shown) may be connected to or can be part of the wireless network environment 100. The location server may assist in determining a location of the mobile devices 104 and 106 relative to the terrestrial wireless transceiver 102. The location server may include the location server 1400 described below with respect to FIG. 14. For example, the location server may include a secure user plane location (SUPL) location platform (SLP) or other type of server configured to store and/or provide location information.

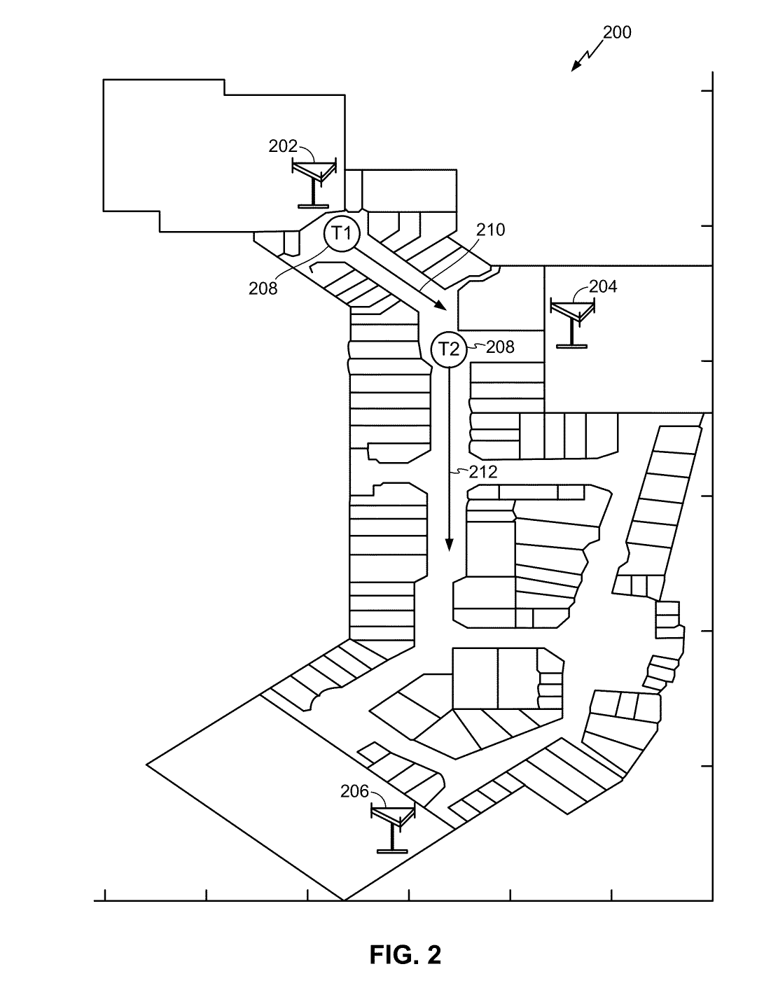

FIG. 2 is an overhead perspective view of an example of a venue 200. The venue 200 may be an office building, indoor or outdoor shopping mall, suburban or urban area, an airport, or any other type of venue. The venue 200 may include an indoor or outdoor area with rooms, walls, and hallways, for example. In some embodiments, the venue 200 may be made up of a number of buildings. As illustrated in FIG. 2, multiple terrestrial wireless transceivers 202, 204, and 206 are located throughout the venue. Terrestrial wireless transceivers 202, 204, and 206 may include, for example, the terrestrial wireless transceiver 1300 described below with respect to FIG. 13.

Terrestrial wireless transceivers 202, 204, and 206 may be placed at known locations according to different design requirements. For example, owners of different businesses or organizations within the venue 200 may selectively place a terrestrial wireless transceiver within a store or other location within the venue 200 in order to provide network service to various customers. As another example, an owner of the entire venue 200, or the collective owners of each business within the venue 200, may strategically determine the location of each of the terrestrial wireless transceivers 202, 204, and 206 so that the coverage areas of each of the terrestrial wireless transceivers 202, 204, and 206 span most or all of the venue 200. In some instances, the terrestrial wireless transceivers 202, 204, and 206 may be operated by the same service provider. In other instances, terrestrial wireless transceiver 202 may be operated by a first service provider, terrestrial wireless transceiver 204 may be operated by a second service provider, and terrestrial wireless transceivers 206 may be operated by a third service provider. The first, second, and third service providers may each be a wireless network operator, the owner or manager of the venue 200, a local communications service provider, a vendor for the terrestrial wireless transceivers 202, 204, or 206, respectively, or some other entity. It will be understood by one of ordinary skill in the art that more or less terrestrial wireless transceivers may be located in the venue 200.

As discussed above, a technician or other user may conduct venue surveys in order to provide indoor positioning data that may be used to generate heat maps for the terrestrial wireless transceivers 202, 204, and 206 located in the venue 200. A mobile device 208 may be used to measure terrestrial wireless transceiver signal data of each terrestrial wireless transceiver 202, 204, and 206. Mobile device 208 may include, for example, the mobile device 1216 described below with respect to FIG. 12. Terrestrial wireless transceiver signal data may include received signal strength indicator (RSSI) measurements, round trip time (RTT) measurements, 2-dimensional or 3-dimensional coordinates, or other types of formats known to those with skill in the art. RSSI signal data indicates the strength of a received signal, and may correspond to an amount of signal loss that has occurred. For example, RSSI may include a difference between transmitted signal strength and signal loss. RSSI may decrease as the travel distance of a signal from a terrestrial wireless transceiver increases. RTT signal data may include an amount of time it takes for a signal to arrive at a destination after being transmitted by a terrestrial wireless transceiver. RTT may increase as the travel distance of a signal increases.

The terrestrial wireless transceiver signal data may be used to generate or update a heat map for each terrestrial wireless transceiver 202, 204, and 206. For example, the measured terrestrial wireless transceiver signal data may be used to predict the signal data (e.g., RSSI, RTT, etc.) for a terrestrial wireless transceiver in the remaining areas of the venue that were not directly measured. In some embodiments, various heat map generation techniques, such as interpolation or regression algorithms, applications, or programs (e.g., linear interpolation, spline, or Gaussian Process Regression (GPR)), may be used to predict the signal data for the terrestrial wireless transceiver over a grid of feasible points in the venue 200. A feasible point includes each point in a venue for which signal data for a terrestrial wireless transceiver may be obtained. For example, a feasible point may be any point within a venue in which a user can be located, such as a hallway, a room, an entrance, or the like. Portions of a venue that may not include a feasible point may include, for example, walls or inaccessible areas within the venue. A heat map may then be generated for each of the terrestrial wireless transceivers 202, 204, and 206 as a result of the prediction.

An application or program operating on mobile device 208 or a location server (not shown) may obtain the signal data for each terrestrial wireless transceiver and may use the signal data to perform the heat map generation techniques, such as the interpolation or regression applications or programs described above, to generate a heat map for each terrestrial wireless transceiver. In some embodiments, the application may also receive other inputs, such as feasible points of the venue, a list of terrestrial wireless transceivers of interest, ground-truth location data of the venue 200 (e.g., map data of the venue, human input, inertial sensor data, gyroscope sensor data, accelerometer sensor data, vision data, GPS data, or the like) gathered by mobile device 208 or another device, maximum or allotted amount of time to generate a heat map, or the like.

The technician may iteratively gather terrestrial wireless transceiver signal data at different locations within the venue. For example, a technician using a mobile device 208 at time T1 may obtain the signal data of terrestrial wireless transceiver 202 within a first area 210 of the venue 200. In some embodiments, an application running on the mobile device 208 may use the signal data (and optionally any other available inputs, such as feasible points of the venue, ground-truth data for the venue 200, and/or a maximum or allotted amount of time to generate the heat map) to generate a heat map for the terrestrial wireless transceiver 202. In other embodiments, the mobile device 208 may transmit the signal data of the terrestrial wireless transceiver 202 to a location server (not shown) with an application that may use the signal data (and optionally any other available inputs) to generate the heat map for the terrestrial wireless transceiver 202.

Once the heat map for the terrestrial wireless transceiver 202 is generated in the first area 210, the application running on the mobile device 208 or the location server may use the heat map to determine position information related to a location of the mobile device 208 within the venue 200. For example, the position information may include an estimated position of the mobile device 208, an accuracy of the position estimate, a number of terrestrial wireless transceivers used to generate the position estimate, and/or the like.

The application may then detect errors or deficiencies of the positioning information. For example, the application may determine that not enough signal data measurements have been obtained, that the position information is not accurate enough given the obtained signal data measurements, and/or the like. In response to detecting the errors, the application may generate feedback relating to the signal data and/or the position of the mobile device 208 within the venue 200. The feedback may be provided to the technician and may indicate that more measurements are required or should be obtained in the first area 210 of the venue 200. The feedback may be provided through a display of the mobile device (e.g., a color coded map), through one or more indicators on the mobile device (e.g., color coded lights), through a speaker of the mobile device as an audio signal, through haptic actuators such as vibration, and/or the like. For example, a color coded map of the venue 200 may be displayed to the technician with different colors in areas of the map indicating the need to gather additional signal data measurements in order to provide an accurate heat map and/or obtain accurate location results using the heat map. As one example, a red color may indicate that an accurate heat map cannot be generated (and/or an accurate location cannot be determined) using the currently obtained measurements and that additional measurements must be obtained in order to generate an accurate heat map (more measurements are required), a yellow color may indicate that the application has sufficient measurements to generate a heat map (and/or to determine an accurate location) but that a more accurate heat map may be generated (or location determined) if additional measurements are obtained (more measurements are recommended), and a green color may indicate that no additional measurements are needed or recommended for the area (no measurements needed). In some embodiments, a legend may be displayed along with the color coded map in order to guide the technician in gathering additional measurements.

In response to the feedback, the technician may use the mobile device 208 to gather any additional signal data for the terrestrial wireless transceiver 202 as indicated by the feedback data. The application operating on the mobile device 208 or the location server may generate an updated heat map using the additional measurements and may determine updated position information using the one or more updated heat maps. Further feedback may be provided to the mobile device 208 if further additional measurements are required or recommended until the heat map can be used to determine sufficiently accurate positioning information for the mobile device 208.

Once a sufficient heat map is available or once enough heat maps are available to generate a position within some threshold uncertainty, the application running on the mobile device 208 or location server may generate a position output to the technician indicating the current position of the mobile device 208 (e.g., on a displayed map or other output). In some embodiments, the technician may compare the generated position output to the actual position of the mobile device at which the technician is positioned. In the event there is a discrepancy or error between the actual position and the generated position output above a certain threshold amount (e.g., one foot, two feet, one yard, and/or the like), the technician may collect additional data at or around the location of the mobile device 208. For example, the technician may input to the application operating on the mobile device 208 or the location server that a position discrepancy or error of a certain amount exists, and the application may respond by directing the technician to collect additional data in certain areas around the location of the mobile device 208.

Once the positioning information within the first area 210 determined using the one or more heat maps becomes sufficiently accurate, the technician may move on to a second area 212 of the venue 200. For example, the technician at time T2 may use the mobile device 208 to gather signal data of terrestrial wireless transceiver 202 within the second area 212 of the venue 200. A heat map may then be generated for the terrestrial wireless transceiver 202 and, using the techniques described above, feedback may be provided to the mobile device 208 indicating whether additional signal data is required or recommended for the area 212 in order to generate a heat map that can be used to provide accurate location or position information. In some embodiments, the technician may gather signal data measurements for the terrestrial wireless transceiver 202 in all of the areas of the venue 200 before the heat map for the terrestrial wireless transceiver 202 is generated and any potential feedback is provided.

Upon obtaining signal data measurements in all areas of the venue 200 for the terrestrial wireless transceiver 202, the technician may use the mobile device 208 to gather signal data for the other terrestrial wireless transceivers 204 and 206 in each of the areas. A heat map may then be generated for the terrestrial wireless transceivers 204, 206 and, using the techniques described above, feedback may be provided to the mobile device 208 indicating whether additional signal data is required or recommended for the different areas in order to generate a heat map for each of the terrestrial wireless transceivers 204 and 206 that can be used to provide accurate location or position information.

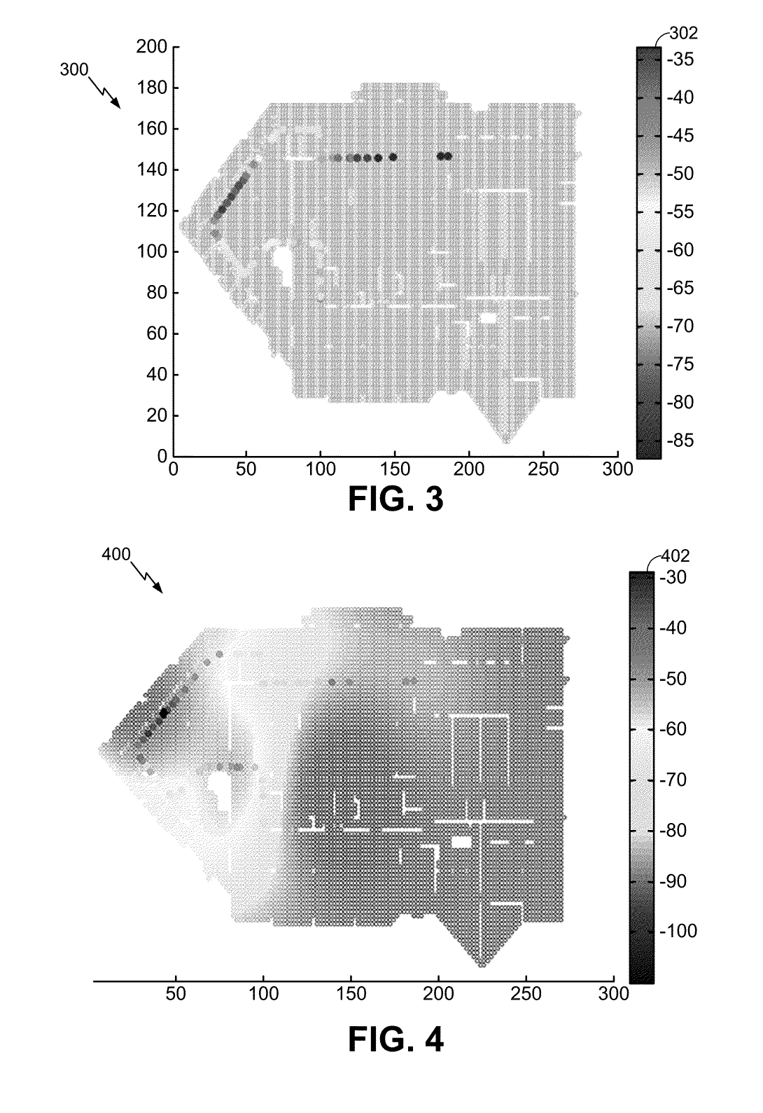

FIG. 3 illustrates an example of a grid of feasible points within a venue 300. The shaded dots represent examples of collected signal data for one terrestrial wireless transceiver within the venue 300. The spectrum 302 indicates the signal strength of the received signal data as descending values going from the top of the spectrum to the bottom (e.g., the darker shading indicates the strongest signal values and lighter shading indicates the weakest signal values). Each of the gray dots throughout the map represent a feasible point. All of the feasible points together form the map and indicate an area over which a heat map is desired. As explained above, a feasible point includes each point in a venue for which signal data for a terrestrial wireless transceiver may be obtained. For example, the grid of feasible points in venue 300 may include all points within the venue 300 in which a user can be located, such as a hallway, a room, an entrance, or the like. Portions of a venue that may not include a feasible point may include, for example, walls or inaccessible areas within the venue and are represented by the white areas illustrated in FIG. 3. The signal data and the feasible points (and optionally ground-truth data for the venue 300 and/or a maximum or allotted amount of time to generate the heat map) may be used as input data for generating a heat map using one or more heat map generation techniques. For example, as described above, interpolation or regression techniques (e.g., linear interpolation, spline, or Gaussian Process Regression (GPR)) may be used to predict the signal data for the terrestrial wireless transceiver over the grid of feasible points in the venue 300.

FIG. 4 illustrates an example of a heat map 400 generated using the input data. The heat map may include a collection of heat map values corresponding to expected or predicted measurements of signal data values (e.g., RSSI, RTT, or the like) at particular locations within the venue 300. For example, a heat map may include heat map signal data values for a terrestrial wireless transceiver at each feasible point within the venue 300. The heat map may include the heat map values along with a map of the venue 300 so that the expected signal data values are shown for various areas within the venue 300. The spectrum 402 indicates the heat map values as descending values going from the top of the spectrum to the bottom. The darker shading to the left indicates stronger values, and, as the shading gets lighter moving from left to right, the signals get weaker. As the shading goes from light to darker, again moving from left to right, the signals become weaker due to the increasing distance from the terrestrial wireless transceiver.

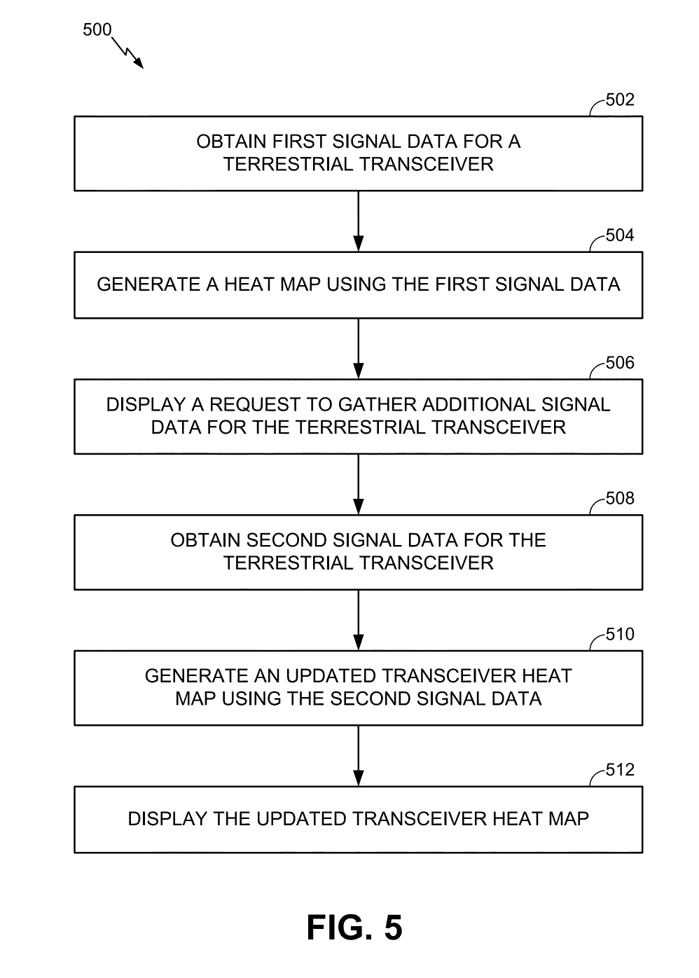

FIG. 5 illustrates an example of a process 500 for creating or updating heat map data using a mobile device. Process 500 is illustrated as a logical flow diagram, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 500 may be performed under the control of one or more computer systems configured with executable instructions and may be implemented as an application or code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium may be non-transitory.

In some aspects, the process 500 may be performed by a mobile device, such as the mobile device 1216 shown in FIG. 12 below.

At 502, a mobile device may obtain first signal data for a terrestrial transceiver. The first signal data may be obtained by mobile device 208 and may relate to the terrestrial wireless transceiver 202. The terrestrial transceiver may be located within a venue, such as venue 200 or 300. For example, the first signal data may include received signal strength indicator (RSSI) measurements, round trip time (RTT) measurements, 2-dimensional or 3-dimensional coordinates, or other types of formats known to those with skill in the art.

At 504, the mobile device may generate a transceiver heat map using the first signal data. In some embodiments, the mobile device may receive further input in order to generate the transceiver heat map. For example, other inputs may include the feasible points of the venue in which the terrestrial transceiver is located, a list of terrestrial wireless transceivers of interest (including the terrestrial transceiver), ground-truth location data of the venue (e.g., map data of the venue, human input, inertial sensor data, gyroscope sensor data, accelerometer sensor data, vision data, GPS data, or the like) gathered by the mobile device or another device, maximum or allotted amount of time to generate the heat map, or the like.

The mobile device may use the heat map to determine position information related to a location of the mobile device. For example, the position information may include an estimated position of the mobile device within a venue that includes the terrestrial transceiver. As another example, the position information may include an accuracy of the position estimate, a number of terrestrial wireless transceivers used to generate the position estimate, and/or the like. In some embodiments, the mobile device may detect errors or deficiencies of the positioning information. For example, the mobile device may determine that an insufficient amount of signal data measurements have been obtained, that the position information is not accurate enough given the obtained signal data measurements, and/or the like.

In response to detecting the errors, the mobile device may generate and may display feedback relating to the signal data and/or the position of the mobile device. For example, at 506, the mobile device may display a request to gather additional signal data for the terrestrial transceiver. The feedback request may be provided through a display of the mobile device as a color coded map. For example, a color coded map of the venue may be displayed to a user (e.g., technician, surveyor, or the like) with different colors in areas of the map indicating the need to gather additional signal data measurements in order to provide an accurate heat map and/or obtain accurate location results using the heat map. As described above, for example, a red color may indicate that more measurements are required, a yellow color may indicate that more measurements are recommended, and a green color may indicate that no additional measurements are needed or recommended. In some embodiments, a legend may be displayed along with the color coded map in order to guide the user in gathering additional measurements. In some embodiments, the feedback may be provided to the user using alternative feedback indicators, such as through one or more visual indicators on the mobile device (e.g., color coded lights), through a speaker of the mobile device as an audio signal, through haptic actuators such as vibration, and/or the like. The alternative feedback indicators may be used in addition to or in lieu of the displayed feedback described above.

In some embodiments, the process 500 further includes determining a quality of the transceiver heat map that was generated using the first signal data, comparing the quality to a predetermined quality threshold, and displaying the request to gather additional signal data in response to the quality being below the predetermined quality threshold. For example, the predetermined quality threshold may be set to indicate when an insufficient amount of signal data measurements have been obtained in order to determine accurate position information of the mobile device.

At 508, the mobile device may obtain second signal data for the terrestrial transceiver. For example, the user may take the mobile device to a particular location within the venue upon receiving the displayed request to gather additional signal data. The mobile device may then obtain the second signal data at the location. At 510, the mobile device may generate an updated transceiver heat map using the second signal data. In some embodiments, the transceiver heat map is updated as the second signal data is obtained. In some embodiments, the mobile device may use other inputs in addition to the second signal data to generate the updated transceiver heat map, such as the feasible points of the venue in which the terrestrial transceiver is located, a list of terrestrial wireless transceivers of interest (including the terrestrial transceiver), ground-truth location data of the venue (e.g., map data of the venue, human input, inertial sensor data, gyroscope sensor data, accelerometer sensor data, vision data, GPS data, or the like) gathered by the mobile device or another device, maximum or allotted amount of time to generate the heat map, or the like. In some embodiments, the mobile device may generate and may display further feedback if further additional signal data measurements are required or recommended. The feedback may be generated using updated heat maps until a heat map is generated that can be used to determine sufficiently accurate positioning information for the mobile device. At 512, the mobile device may display the updated transceiver heat map. If needed, the user may continue collecting measurements in another part of the venue once the positioning information determined using the updated heat map becomes sufficiently accurate.

In some embodiments, the mobile device may generate a position output indicating the current position of the mobile device and the position output may be displayed to the user (e.g., along with the heat updated map, on a displayed venue map, or other output). In some embodiments, the user may compare the generated position output to the actual position of the mobile device at which the user is positioned. The user may determine that a discrepancy or error exists between the actual position and the generated position output and that the error is above a certain threshold amount (e.g., one foot, two feet, one yard, and/or the like). In the event a discrepancy or error exists, the technician may collect additional data at or around the location of the mobile device. For example, the technician may provide input to the mobile device indicating that a position discrepancy or error of a certain amount exists, and the mobile device may respond by directing the technician to collect additional data in certain areas around the location of the mobile device.

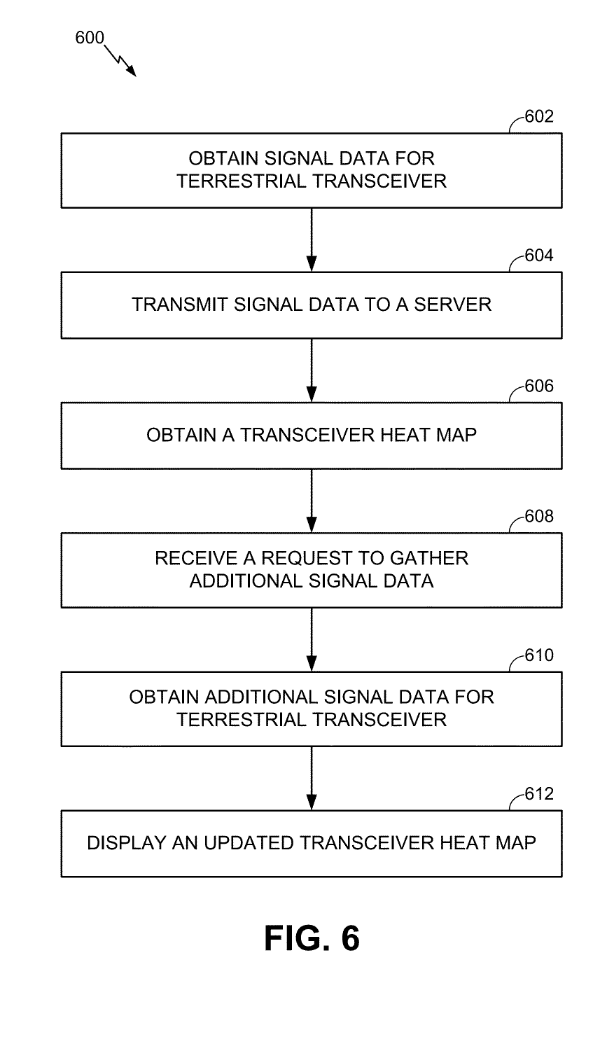

FIG. 6 illustrates an example of a process 600 for creating or updating heat map data using a mobile device and a server (e.g., a location server). Process 600 is illustrated as a logical flow diagram, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 600 may be performed under the control of one or more computer systems configured with executable instructions and may be implemented as an application or code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium may be non-transitory.

In some aspects, the process 600 may be performed by a mobile device, such as the mobile device 1216 shown in FIG. 12 below.

At 602, a mobile device may obtain first signal data for a terrestrial transceiver. The first signal data may be obtained by mobile device 208 and may relate to the terrestrial wireless transceiver 202. The terrestrial transceiver may be located within a venue, such as venue 200 or 300. The first signal data may include, for example, received signal strength indicator (RSSI) measurements, round trip time (RTT) measurements, 2-dimensional or 3-dimensional coordinates, or other types of formats known to those with skill in the art.

At 604, the mobile device may transmit the first signal data to a server. The server may include the location server 1400 described below with respect to FIG. 14. The server may generate a transceiver heat map using the first signal data. In some embodiments, the server may receive further input in order to generate the transceiver heat map. For example, other inputs may include the feasible points of the venue in which the terrestrial transceiver is located, a list of terrestrial wireless transceivers of interest (including the terrestrial transceiver), ground-truth location data of the venue (e.g., map data of the venue, human input, inertial sensor data, gyroscope sensor data, accelerometer sensor data, vision data, GPS data, or the like) gathered by the mobile device or another device, maximum or allotted amount of time to generate the heat map, or the like.

At 606, the mobile device may obtain the transceiver heat map. For example, the server may transmit the generated heat map to the mobile device. The mobile device or the server may use the heat map to determine position information related to a location of the mobile device, such as a position estimate of the mobile device within a venue that includes the terrestrial transceiver, an accuracy of the position estimate, a number of terrestrial wireless transceivers used to generate the position estimate, and/or the like. In some embodiments, the server may detect errors or deficiencies of the positioning information. For example, the server may determine that an insufficient amount of signal data measurements have been obtained, that the position information is not accurate enough given the obtained signal data measurements, and/or the like.

In response to detecting the errors, the server may generate feedback relating to the signal data and/or the position of the mobile device. The server may then transmit the feedback to the mobile device. At 608, the mobile device may receive a request to gather additional signal data for the terrestrial transceiver. The received feedback request may be presented to the user through a display of the mobile device as a color coded map. For example, a color coded map of the venue may be displayed to a user (e.g., technician, surveyor, or the like) with different colors in areas of the map indicating the need to gather additional signal data measurements in order to provide an accurate heat map and/or obtain accurate location results using the heat map. For example, a red color may indicate that more measurements are required, a yellow color may indicate that more measurements are recommended, and a green color may indicate that no additional measurements are needed or recommended. In some embodiments, a legend may be displayed along with the color coded map in order to guide the technician in gathering additional measurements. In some embodiments, the feedback may be provided to the user using alternative feedback indicators, such as through one or more visual indicators on the mobile device (e.g., color coded lights), through a speaker of the mobile device as an audio signal, through haptic actuators such as vibration, and/or the like. The alternative feedback indicators may be used in addition to or in lieu of the displayed feedback described above.

In some embodiments, the server may determine a quality of the transceiver heat map that was generated using the first signal data, compare the quality to a predetermined quality threshold, and submit the request to gather additional signal data in response to the quality being below the predetermined quality threshold. As a result, the mobile device may receive the request to gather additional signal data in response to the quality of the transceiver heat map being below the predetermined quality threshold. In some embodiments, the predetermined quality threshold may be set to indicate when an insufficient amount of signal data measurements have been obtained in order to determine accurate position information of the mobile device.

At 610, the mobile device may obtain second signal data for the terrestrial transceiver. For example, the user may take the mobile device to a particular location within the venue upon receiving the displayed request to gather additional signal data. The mobile device may then obtain the second signal data at the location. The mobile device may transmit the second signal data to the server and the server may generate an updated transceiver heat map using the second signal data. In some embodiments, the server may use other inputs in addition to the second signal data to generate the updated transceiver heat map, such as the feasible points of the venue in which the terrestrial transceiver is located, a list of terrestrial wireless transceivers of interest (including the terrestrial transceiver), ground-truth location data of the venue (e.g., map data of the venue, human input, inertial sensor data, gyroscope sensor data, accelerometer sensor data, vision data, GPS data, or the like) gathered by the mobile device or another device, maximum or allotted amount of time to generate the heat map, or the like. In some embodiments, the server may generate further feedback and provide the further feedback to the mobile device if further additional signal data measurements are required or recommended. The feedback may be generated using updated heat maps until a heat map is generated that can be used to determine sufficiently accurate positioning information for the mobile device. The mobile device may then obtain the updated transceiver heat map from the server. At 612, the mobile device may display the updated transceiver heat map. If needed, the user may continue collecting measurements in another part of the venue once the positioning information determined using the updated heat map becomes sufficiently accurate.

In some embodiments, the mobile device or the server may generate a position output indicating the current position of the mobile device and the position output may be displayed to the user (e.g., along with the heat updated map, on a displayed venue map, or other output). In some embodiments, the user may compare the generated position output to the actual position of the mobile device at which the user is positioned. The user may determine that a discrepancy or error exists between the actual position and the generated position output and that the error is above a certain threshold amount (e.g., one foot, two feet, one yard, and/or the like). In the event a discrepancy or error exists, the technician may collect additional data at or around the location of the mobile device. For example, the technician may provide input to the mobile device indicating that a position discrepancy or error of a certain amount exists. In some embodiments, the mobile device may provide the input to the location server. The mobile device may then receive a response from the server directing the mobile device to prompt the technician to collect additional data in certain areas around the location of the mobile device.

The processes 500 and/or 600 may further include reducing the computational time for generating and/or updating heat maps. For example, heat map generation techniques, such as an interpolation or regression application or program (e.g., linear interpolation, spline, or Gaussian Process Regression (GPR)), may use various inputs to generate one or more heat maps. As described above, the inputs may include feasible points of a venue and signal data measurements. Using the inputs, the heat map generation techniques may predict the signal data for a given terrestrial wireless transceiver at each feasible point using the signal data measurements. The computational time to generate the heat maps may be reduced by reducing the amount of feasible points and/or signal data measurements used by the heat map generation techniques. By reducing the computational time to generate and/or update a heat map, the heat map may be quickly generated (e.g., on a scale of seconds or minutes) so that any potential feedback information can be provided to the user in time for the user to conduct the venue survey in a single visit. The reduction in computational time also allows the entire heat map generation and updating process to occur on the mobile device as opposed to requiring the use of a server-based system. However, a server-based system may be used in some embodiments to provide near real-time feedback information in an allotted amount of time using the computational reduction techniques described herein.

For example, the processes 500 and/or 600 may include obtaining, by the mobile device or server, a transceiver heat map generation constraint. Further, the mobile device or server may determine a subset of the first signal data to use for generating the transceiver heat map based, at least in part, on the transceiver heat map generation constraint. The mobile device or server may generate the transceiver heat map using the subset of the first signal data. In some embodiments, the transceiver heat map generation constraint may include a maximum or allotted time for generating the transceiver heat map. For example, a user (e.g., technician, surveyor, or other user) may input an amount of time that they are willing to wait for the heat maps to be generated or updated. The mobile device or server may determine an estimated time for generating the transceiver heat map using the currently obtained signal data for the terrestrial transceiver. The mobile device or server may compare the maximum time to the estimated time, and may determine the subset of the first signal data to use for generating the transceiver heat map based on the comparison. Various techniques may be used to determine the subset of data based on the heat map generation constraint and to generate one or more transceiver heat map using the subset of data.

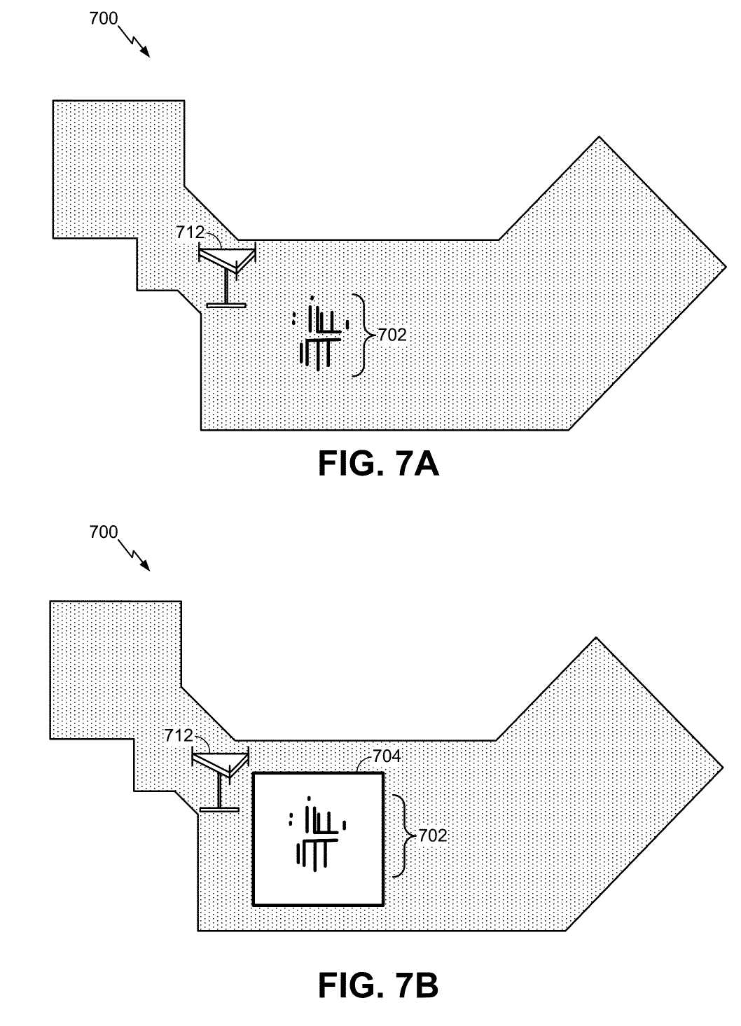

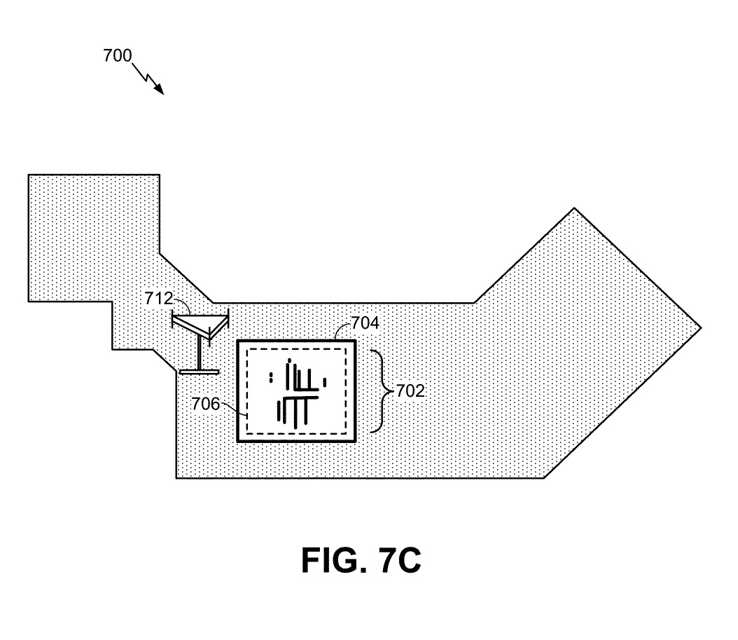

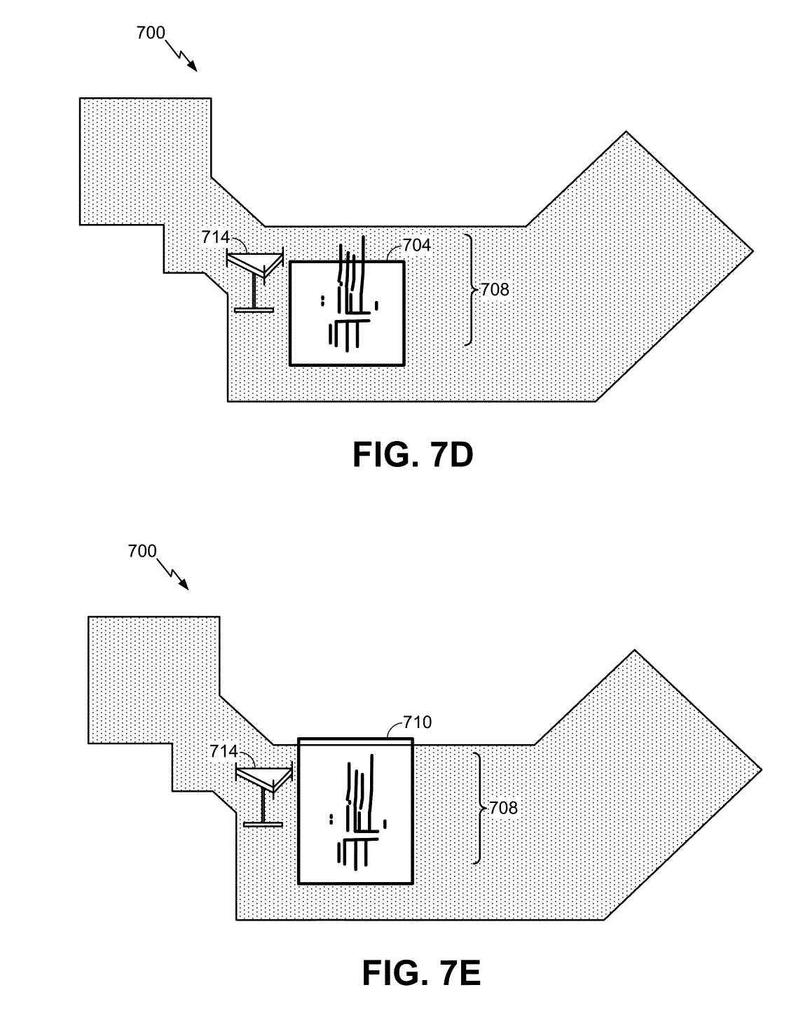

FIGS. 7A-7E illustrate one example of reducing the time required to generate or update a heat map by reducing a number of feasible points used to generate a heat map. In some embodiments, the transceiver heat map generation constraint may further include a maximum number of data points to use for generating the transceiver heat map, the data points including a plurality of feasible points of a venue. The server or mobile device may determine the subset of the first signal data by determining a subset of the plurality of feasible points to use for generating the transceiver heat map. For example, when the maximum amount of time is smaller than the estimated time to generate the heat map, the feasible points may be intelligently reduced with minimal impact on the output heat map.

Referring to FIG. 7A, a venue 700 is shown with a set of signal data measurements 702 of a terrestrial wireless transceiver 712. The venue 700 may include a large area and thus may include multiple terrestrial wireless transceivers. Each terrestrial wireless transceiver, including transceiver 712, may only provide wireless network coverage to a portion of the venue 700. For example, while conducting a venue survey, a user (e.g., technician, surveyor, or the like) may only observe the signal data measurements 702 from terrestrial transceiver 712, whereas the venue 700 as a whole may include a large amount of feasible points as compared to the number of feasible points for which signal data measurements 702 have been obtained. Each of the feasible points within the venue 700 includes a point for which signal data for any terrestrial wireless transceiver within the venue 700 may be obtained. For example, a feasible point may be any point within a venue in which a user can be located, such as a hallway, a room, an entrance, or the like. Portions of a venue that may not include a feasible point may include, for example, walls or inaccessible areas within the venue.

A heat map generation technique, such as an interpolation or regression application or program (e.g., linear interpolation, spline, or Gaussian Process Regression (GPR)), may use the entire grid of feasible points within the venue 700 in order to generate a heat map for the terrestrial transceiver that generated the signal data measurements 702. However, using the entire grid of feasible points to generate the heat maps may lead to large computational times. In some embodiments, the computational time that the heat map generation techniques require to generate or update a heat map may be reduced by determining a subset of the feasible points surrounding the signal data measurements 702 that may be used as input by the heat map generation techniques. For example, as illustrated in FIG. 7B, a bounding box 704 may be generated around the measurements 702 so that the heat map generation techniques are performed using only the feasible points within the bounding box 704. The bounding box 704 may be sized to include only those feasible points within the venue 700 at which it is physically possible to detect signals from the terrestrial wireless transceiver 712. As a result, the accuracy of the generated or updated heat map is not compromised because all possible signal data measurements for the terrestrial wireless transceiver 712 will be included within the bounding box 704 and used by the heat map generation techniques. In some embodiments, the heat map generation techniques may use noise floor data for all feasible points outside of the bounding box 704. For example, the value for the heat map can be set to a noise floor level for feasible points outside of the bounding box 704. The noise floor level, for example, may be between the range of −90 db to −110 db.

In some embodiments, the size of the bounding box 704 may be a function of the transmission power of the terrestrial wireless transceiver 712. The transmission power may be estimated from the signal data of the terrestrial wireless transceiver 712. For example, the transmission power of the terrestrial wireless transceiver 712 may be estimated from the max RSSI measured from the terrestrial wireless transceiver 712, and the bounding box 704 may be sized so that it encompasses all possible signal data measurements at the max RSSI from the transceiver 712. In some embodiments, the size of the bounding box 704 may be predetermined based on radio wave propagation principles. For example, it may be predetermined that signal attenuation of 60 db occurs at a distance of 100 feet from the terrestrial wireless transceiver 712. Based on predetermined attenuation, the bounding box 704 may be sized to surround the terrestrial wireless transceiver 712 at a distance of 120 feet so that no signal data measurements can be detected outside of the bounding box 704.

In some embodiments, as illustrated in FIG. 7C, the signal data measurements 702 obtained by the mobile device may be augmented in order to ensure continuous values for the heat map at the boundary of the bounding box 704. For example, the signal data measurements 702 may be augmented with virtual measurements 706 that include noise floor signal values (e.g., RSSI values), or values close to the noise-floor, at the edge of the bounding box. The noise floor signal values may imply and be interpreted by the heat map generation program or application to indicate an absence of measurements from the terrestrial wireless transceiver 712. By providing the virtual measurements 706 as input to the heat map generation program or application to indicate the absence of measurements at those points, the heat map generation program or application will generate a heat map with values closer to noise floor values at those feasible points. As a result, the virtual measurements 706 ensure that the heat map generation program or application generates a continuous heat map without large discontinuity between estimated signal strength values. For example, without the virtual measurements 706, the heat map generation techniques may generate estimated values around −80 db at the boundary of the bounding box 704 and values around −96 db may be set for feasible points outside of the bounding box. By using the virtual measurements 706 as input in the heat map generation techniques, values around −90 db may be generated at the boundary of the bounding box 704, which is much closer to the −96db values set for the feasible points outside of the bounding box.

In some embodiments, one or more terrestrial wireless transceivers within the venue 700 may include one or more high gain antennas in order to cover a larger area than a lower gain antenna. Referring to FIG. 7D, terrestrial wireless transceiver 714 includes a high gain antenna and may therefore provide wireless network access to a larger area of the venue 700. As described above, the size of the bounding box 704 may be predetermined based on radio wave propagation principles. However, the predetermined bounding box 704 may not capture all feasible points that include signal data from terrestrial wireless transceivers with high gain antennas. In order to capture all signal data from high gain terrestrial wireless transceiver 714, the bounding box 704 may be dynamically resized. For example, the mobile device or server may detect if any of the signal data measurements (or ground truth information) fall outside of the box 704, and may enlarge the box 704 to generate bounding box 710 in order to capture all of the signal data measurements from the high gain terrestrial wireless transceiver 714. In some embodiments, the mobile device or server application may detect the terrestrial wireless transceiver 714 with the high gain antenna and may provide an alert to the user upon detecting the high gain transceiver 714. The alert may direct the user to collect more measurements in the areas covered by the high gain terrestrial wireless transceiver 714 in order to improve the heat map of the transceiver 714.

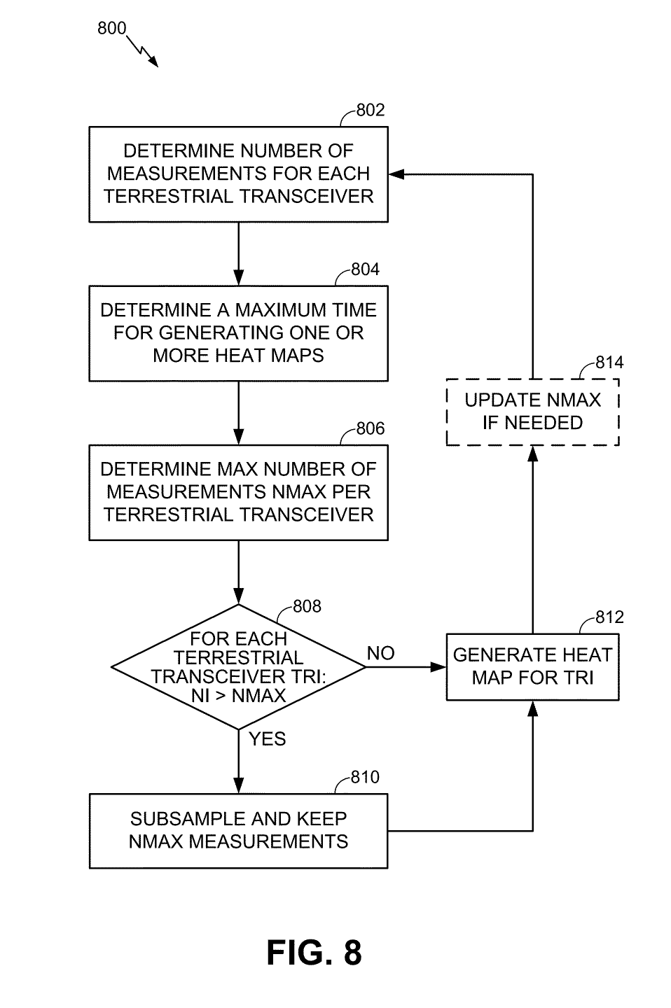

FIGS. 8-11 illustrate another example of reducing the time required to generate or update a heat map by reducing a number of signal data measurements used to generate a heat map. When generating heat maps for a number of terrestrial wireless transceivers, the number of measurements obtained from each terrestrial wireless transceiver may be widely different. For example, signal data measurements of some terrestrial wireless transceivers may be observed more often than others. The processing time for generating a heat map for each terrestrial wireless transceiver is directly related to the number of measurements from each terrestrial wireless transceiver. Accordingly, the number of measurements of each terrestrial wireless transceiver may be reduced in order to reduce the amount of processing time it takes to generate a heat map for each terrestrial wireless transceiver. In some embodiments, the transceiver heat map generation constraint described above includes a maximum number of data points to use for generating the transceiver heat map, the data points including a plurality of signal data measurements of the terrestrial transceiver. The signal data measurements may include, for example, signal strength measurements (e.g., RSSI, RTT, or the like). The server or mobile device may determine the subset of the first signal data by determining a subset of the plurality of signal strength measurements to use for generating the transceiver heat map. For example, when the maximum amount of time is smaller than the estimated time to generate the heat map, the amount of signal data measurements that are used in the generation of the heat map may be intelligently reduced with minimal impact on the resulting heat map.

FIG. 8 illustrates an example of a process 800 for reducing a number of signal data measurements used in the heat map generation techniques, such as interpolation or regression applications or programs (e.g., linear interpolation, spline, or Gaussian Process Regression (GPR)). Process 800 is illustrated as a logical flow diagram, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 800 may be performed under the control of one or more computer systems configured with executable instructions and may be implemented as an application or code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium may be non-transitory.

In some aspects, the process 800 may be performed by a mobile device, such as the mobile device 1216 shown in FIG. 12 below or the location server 1400 shown in FIG. 14 below.

At 802, a mobile device or server may determine the number of signal data measurements for each terrestrial wireless transceiver within a venue or other location. Each of the terrestrial transceivers may be designated as TR₁, TR₂, TR₃ . . . TRᵢ. The terrestrial wireless transceivers may be located within a venue, such as venue 200 or 300. The signal data measurements may include RSSI measurements, RTT measurements, 2-dimensional or 3-dimensional coordinates, or other types of formats known to those with skill in the art.

At 804, the mobile device or server may determine a maximum or allotted time for generating one or more heat maps for one or more of the terrestrial transceivers. In some embodiments, the maximum or allotted time may be input by a user (e.g., technician, surveyor, or other user). For example, a technician conducting a venue survey may input an amount of time that they are willing to wait for the one or more heat maps to be generated or updated. In some embodiments, the maximum amount of time may relate to a time to generate a heat map for terrestrial transceiver TR₁. In some embodiments, the maximum amount of time may relate to a total time to generate heat maps for all of the terrestrial transceivers TR₁, TR₂, TR₃ . . . TR₁. In such embodiments, the maximum amount of time may be divided evenly among each of the terrestrial transceivers. For example, if a user indicates that the maximum amount of time for generating all the heat maps for terrestrial transceivers TR₁, TR₂, TR₃ . . . TRᵢ, is one minute and there are ten terrestrial transceivers, the mobile device or server may determine that a maximum amount of time for generating a heat map for each terrestrial transceiver is 0.1 minutes.

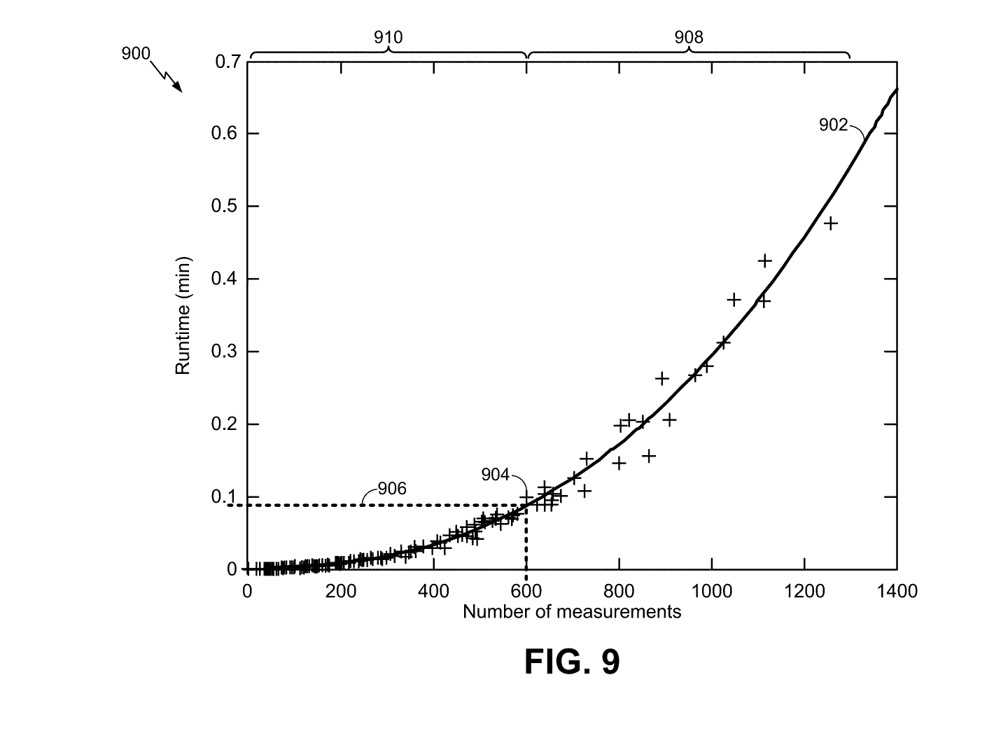

At 806, the mobile device or server may determine a maximum number of measurements (Nₘₐₓ) per terrestrial transceiver. Nₘₐₓ may be determined based on the maximum or allotted time obtained by the mobile device or server. For example, FIG. 9 illustrates a graph 900 with a number of signal data measurements per amount of runtime. The graph 900 shows an example of a number of measurements observed for various terrestrial wireless transceivers in a venue, and the time it takes to compute a heat map for each AP (e.g., using linear interpolation, spline, Gaussian Process Regression, or the like). Each of the + signs along the curve 902 represent a terrestrial wireless transceiver, for example terrestrial wireless transceiver 904. The graph 900 illustrates that 600 measurements were obtained for terrestrial wireless transceiver 904, and that it took approximately 0.1 minutes to generate a heat map for the terrestrial wireless transceiver 904. The curve 902 may be generated using a second or third order polynomial and may be used to determine the maximum number of measurements (Nₘₐₓ) that may be used from each terrestrial wireless transceiver given the maximum or allotted amount of time. For example, the mobile device or server may determine at step 804 that 0.1 minutes is the maximum or allotted time for generating a heat map for each terrestrial wireless transceiver. Referring to FIG. 9, the dotted line 906 indicates that Nₘₐₓ for each terrestrial wireless transceiver for the allotted time is 600 measurements.

Referring to FIG. 9, if the total maximum or allotted time for generating heat maps for the terrestrial transceivers in the venue is less than an estimated time to generate the heat maps, the mobile device or server may subsample the measurements of those terrestrial wireless transceivers 908 that have a number of measurements over Nₘₐₓ. The terrestrial wireless transceivers 910 that do not have measurements over Nₘₐₓ may or may not be subsampled. Referring to FIG. 8, the mobile device or server at 808 may determine whether the number of measurements for each terrestrial wireless transceiver TRᵢ is greater than Nₘₐₓ. In the event the mobile device or server determines that Nᵢ is greater than Nₘₐₓ for a given terrestrial transceiver TRᵢ, the signal data measurements for TRi may be subsampled at 810 so that only the measurements up to Nₘₐₓ are used to generate the heat map. In some embodiments, subsampling of the signal data measurements may be done randomly so that the signal data measurements that are chosen for use in the heat map generation techniques are randomly chosen. In some embodiments, subsampling of the signal data measurements may be done deterministically. For example, the mobile device or server may remove one measurement, keep two sequential measurements, remove one measurement, keep two sequential measurements, and so on. As another example of deterministic subsampling, the mobile device or server may remove every other signal data measurement. In some aspects, areas that have higher concentration of measurements and/or low signal data measurement levels may be given a higher priority for subsampling. For example, if a certain area has a high concentration of measurements, more of the measurements may be removed as compared to an area with a small concentration of measurements. It will be understood by one of ordinary skill in the art that other types or examples of subsampling may be used to determine the measurements for use in generating the heat maps.

At 812, a heat map is generated for the terrestrial wireless transceiver TRᵢ. For example, the heat map may be generated after the measurements for TRᵢ have been subsampled at 810. In the event the mobile device or server determines that Nᵢ is not greater than Nₘₐₓ for a given terrestrial transceiver TRᵢ, the signal data measurements for TRi are not subsampled and the heat map for TRᵢ, is generated at 812 using all of the signal data measurements. Steps 806-812 may be iteratively repeated until a heat map is generated for each of the terrestrial transceiver TR₁, TR₂, TR₃ . . . TRᵢ.

In some embodiments, an optional step 814 may be performed in order to update Nₘₐₓ if the mobile device or server determines that Nₘₐₓ needs to be updated. For example, the mobile device or server may determine that Nₘₐₓ needs to be updated if the actual computational time for generating a heat map for TRᵢ deviates from the predicted time due to computational overheads. The actual computational time may fluctuate due to the overheads of computations that are not accounted for in the polynomial formula used to determine Nₘₐₓ. In order to adhere to the maximum or allotted time, the maximum number of allowed measurements Nₘₐₓ per terrestrial transceiver TRᵢ may be modified at 814 to reflect the latest estimates of remaining time. For example, referring to FIG. 9, the predicted amount of time to generate a heat map for terrestrial wireless transceiver 904 may be 0.1 minutes. However, in some instances, the actual amount of time to generate the heat map for terrestrial wireless transceiver 904 may be more or less than 0.1 minutes (or 6 seconds). The remaining allotted amount of time may then be adjusted for all subsequently generated heat maps to account for the deviation between the predicted and actual time. For example, if the actual amount of time to generate the heat map for terrestrial wireless transceiver 904 is seven seconds, the remaining allotted amount of time may be adjusted down by one second. The remaining amount of time may then be divided among the total amount of terrestrial transceivers TR₁, TR₂, TR₃ . . . TRᵢ and the Nₘₐₓ may be adjusted accordingly (using the curve 902) so that Nₘₐₓ is decreased. As another example, the actual amount of time may be less than the predicted amount of time, in which case Nₘₐₓ may be increased due to an increase in the remaining amount of time. As a result, Nₘₐₓ may be adaptively adjusted as each heat map is generated due to one or more of the heat maps taking more or less time than predicted so that more or less time can be used to generate subsequent heat maps.

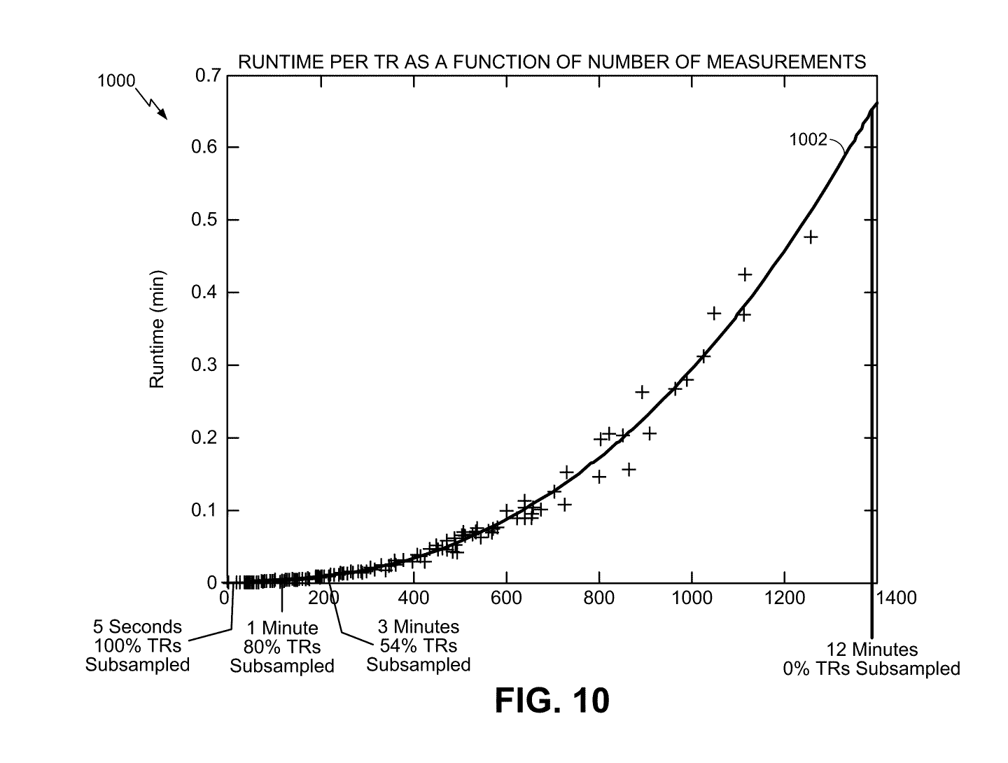

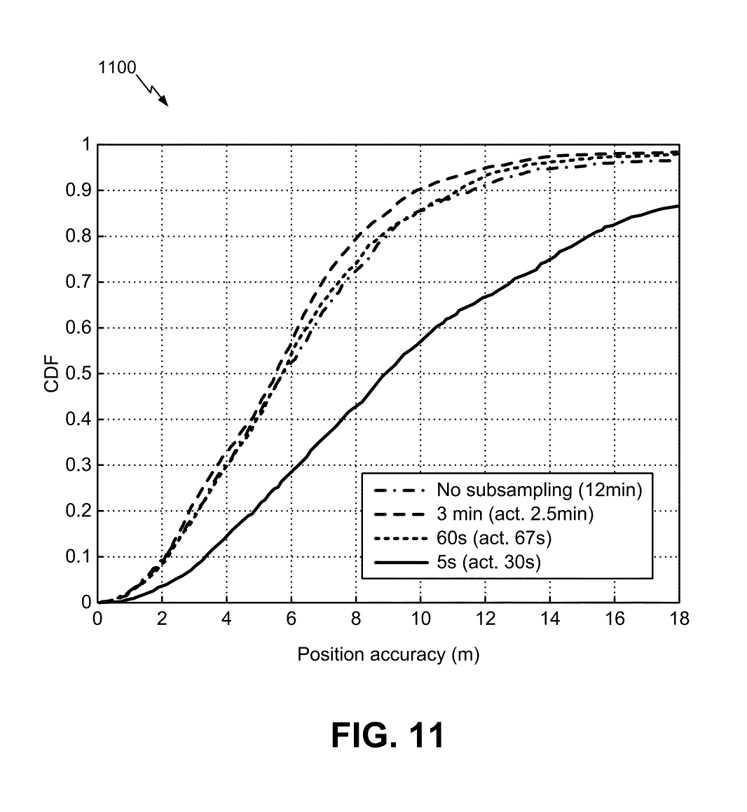

FIG. 10 is a graph 1000 showing an example of runtime results based on reducing a number of measurements used to generate a heat map. The curve 1002 may be generated using a second or third order polynomial and may be used to determine a total time for which computation of the heat maps for all of the terrestrial transceivers (TRs) will take given a particular number of terrestrial transceivers that are subsampled. For example, if 0% of the terrestrial wireless transceivers are subsampled, the mobile device or server may use the second or third order polynomial (curve 1002) to determine that it will take twelve minutes to generate heat maps for all of the terrestrial wireless transceivers. As another example, the mobile device or server may determine that it will take three minutes to generate heat maps for all of the terrestrial wireless transceivers if 54% of the terrestrial wireless transceivers are subsampled. As yet another example, the mobile device or server may determine that it will take one minute to generate heat maps for all of the terrestrial wireless transceivers if 80% of the terrestrial wireless transceivers are subsampled. As another example, the mobile device or server may determine that it will take 5 seconds to generate a heat map for all of the terrestrial wireless transceivers if 100% of the terrestrial wireless transceivers are subsampled. Based on the analysis, the mobile device or server may determine an optimal number of terrestrial transceivers to subsample in order to generate heat maps that are sufficient to provide a desired level of position accuracy. For example, the mobile device or server may determine that subsampling 54% of the terrestrial transceivers in order to generate all of the heat maps in three minutes or less will not negatively impact the resulting accuracy of the position determination using the heat maps. On the other hand, the mobile device or server may determine that if 80% of the terrestrial transceivers are subsampled, the position accuracy will be negatively affected in such a way that saving an extra two minutes of computational time is not worth the loss of accuracy. FIG. 11 is a graph illustrating the position accuracy resulting from reduction of a number of measurements used to generate a heat map that is used to determine the position.

Accordingly, intelligent techniques are provided for allowing a user to conduct a venue survey in an allotted amount of time by generating and displaying feedback to the user. Further, intelligent techniques are provided for subsampling the measurements and/or reducing the feasible points without compromising the accuracy of the constructed heat map so that the heat map and any feedback may be generated within the allotted amount of time.

FIG. 12 is a block diagram illustrating an example of a mobile device 1216, according to some embodiments. The mobile device 1216 may be a cellphone, smartphone, PDA, tablet, laptop, tracking device, or some other wireless supportable and moveable device. The mobile device 1216 may be referred to herein as a mobile terminal, mobile station (MS), terminal, device, wireless device, user equipment (UE), SUPL Enabled Terminal (SET), target device, target, or by some other name. The location of mobile device 1216 may be referred to herein as a location estimate, position, or position estimate and the operation whereby the location is obtained may be referred to as location, locating, positioning or by some other name.

The mobile device 1216 includes hardware elements that can be electrically coupled via a bus 1201 (or may otherwise be in communication, as appropriate). In one embodiment, the bus 1201 can be used for the processor 1211 to communicate between cores and/or with the memory 1261. The hardware elements may include one or more processors (e.g., processor 1211), including without limitation one or more general-purpose processors and/or one or more special-purpose processors (such as digital signal processing chips, graphics acceleration processors, and/or the like); one or more input devices 1241, which can include without limitation a camera, a mouse, a keyboard, a touch sensitive screen, a touch pad, a keypad, and/or the like; and one or more output devices 1251, which can include, without limitation, a display, a printer, and/or the like.

The mobile device 1216 may include one or more wireless transceivers 1231 connected to the bus 1201. The wireless transceiver 1231 may be operable to receive a wireless signal 1234 via antenna 1232. The wireless signal 1234 may be transmitted via a wireless network. In some embodiments, the wireless network may be any wireless network such as a wireless LAN (WLAN) such as WiFi, a Personal Access Network (PAN), such as Bluetooth™ or Zigbee™, or a cellular network (e.g. a GSM, WCDMA, LTE, CDMA2000 network). In some embodiments, antennas 1232 and 1272 may be the same antenna. Wireless transceiver 1231 may be configured to receive various radio frequency (RF) signals 1234 via antenna 1232 from one or more terrestrial wireless transceivers, such as, but not limited to, wireless access points and femtocells. Mobile device 1216 may be configured to obtain signal data for the terrestrial wireless transceivers. The signal data may come in various forms, including ranging information for terrestrial wireless transceivers, such as received signal strength indicator (RSSI) measurements, round trip time (RTT) measurements, 2-dimensional or 3-dimensional coordinates, or other types of formats known to those with skill in the art. In some embodiments, mobile device 1216 may be configured to communicate with a location server in order to transmit signal data and receive heat maps and feedback information. Mobile device 1216 may also be configured to decode and/or decrypt, via the DSP 1221 and/or general purpose processor 1211, some or all of the information provided by the terrestrial wireless transceivers, in the event that, for example, some information (e.g. location coordinates of a transceiver) was encoded or encrypted. In some embodiments, mobile device 1216 may be configured to process the wireless signals 1234, in whole or in part, generate one or more heat maps, and/or determine the location of the mobile device 1216 using the one or more heat maps. In some embodiments, mobile device 1216 may be configured to process the wireless signals 1234, and a location server may generate one or more heat maps and/or determine the location of the mobile device 1216 using the one or more heat maps. In some embodiments, multiple wireless transceivers 1231 may be used for location determination and/or communication. For example, in some embodiments, a WAN transceiver, a WLAN transceiver and/or a PAN transceiver, or any combination of the above, may be used for communication and/or location purposes. In some embodiments, multiple transceivers of similar type such as multiple WAN transceivers for the support of multiple air interfaces and/or multiple PAN interfaces such as for the support of both Bluetooth and Zigbee may be used for communication and/or location purposes.

The mobile device 1216 may also include a global navigation satellite system (GNSS) receiver 1271 capable of receiving GNSS signals 1274 via a GNSS antenna 1272 coupled to the GNSS receiver 1271. The GNSS receiver 1271 may also process, in whole or in part, the GNSS radio signals 1274 and use the GNSS signals 1274 to determine the location of the mobile device 1216. In some embodiments, processor(s) 1211 (general-purpose and/or specialized processors), memory 1261, and/or DSP(s) 1221 may also be utilized to process the GNSS signals 1274, in whole or in part, and/or calculate the location of the mobile device 1216, in conjunction with GNSS receiver 1271. The storage of GNSS or other location signals may be done in memory 1261 or other registers (not shown).

The mobile device 1216 may further include (and/or be in communication with) one or more non-transitory storage devices (e.g., memory 1261), which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The mobile device 1216 may include DSP(s) 1221 connected to a bus 1201, processor(s) 1211 connected to the bus 1201, and memory 1261 connected to the bus 1201. In various embodiments, functions may be stored as one or more instructions or code in memory 1261, such as on a computer-readable storage medium, such as RAM, ROM, FLASH, or disc drive, and executed by processor(s) 1211 or DSP(s) 1221. The mobile device 1216 can also comprise software elements (e.g., located within the memory 1261), including, for example, an operating system, device drivers, executable libraries, and/or other code, such as one or more application programs, which may comprise computer programs implementing the functions provided by various embodiments, and/or may be designed to implement methods and/or configure systems, as described herein. Merely by way of example, one or more procedures described with respect to the processes discussed above, for example as described with respect to FIGS. 5, 6, and 8, may be implemented as code and/or instructions executable by a computer (and/or a processor within a computer); in an aspect, then, such code and/or instructions can be used to configure and/or adapt a general purpose computer (or other device) to perform one or more operations in accordance with the described methods. Such functions or code may include code to obtain signal data for a terrestrial transceiver, code to generate a transceiver heat map using the first signal data, code to display a request to gather additional signal data for the terrestrial transceiver, code to obtain second signal data for the terrestrial transceiver, code to generate an updated transceiver heat map using the second signal data, and code to display the updated transceiver heat map. In some embodiments, the functions or code may include code to obtain signal data for a terrestrial transceiver, code to transmit the first signal data to a server, code to obtain a transceiver heat map generated using the first signal data, code to receive a request to gather additional signal data for the terrestrial transceiver, code to obtain second signal data for the terrestrial transceiver, and code to display an updated transceiver heat map that is updated using the second signal data. Memory 1261 may be a processor-readable memory and/or a computer-readable memory that stores software code (programming code, instructions, etc.) configured to cause the processor(s) 1211 and/or DSP(s) 1221 to perform the functions described. In other embodiments, the functions described may be performed in hardware.

A set of these instructions and/or code might be stored on a computer-readable storage medium, such as the memory 1261. In some cases, the storage medium might be incorporated within a computer system, such as mobile device 1216. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the mobile device 1216 and/or might take the form of source and/or installable code, which, upon compilation and/or installation on the mobile device 1216 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other mobile or computing devices such as network input/output devices may be employed.

Some embodiments may employ a computer system to perform methods or processes in accordance with the disclosure. For example, some or all of the procedures of the described processes may be performed by the mobile device 1216 in response to processor 1211 executing one or more sequences of one or more instructions (which might be incorporated into an operating system and/or other code, such as an application program) contained in the memory 1261. Such instructions may be read into the memory 1261 from another computer-readable medium, such as one or more of the storage device(s). Merely by way of example, execution of the sequences of instructions contained in the memory 1261 might cause the processor(s) 1211 to perform one or more procedures of the methods described herein, for example one or more of the elements of the method described with respect to FIGS. 5, 6, and 8.

FIG. 13 illustrates an example of a terrestrial wireless transceiver 1300, according to some embodiments. The terrestrial wireless transceiver 1300 includes hardware elements that can be electrically coupled via a bus 1301 (or may otherwise be in communication, as appropriate). In one embodiment, the bus 1301 can be used for the processor 1310 to communicate between cores and/or with the memory 1340. The hardware elements may include one or more processors (e.g., processor 1310), including without limitation one or more general-purpose processors and/or one or more special-purpose processors (such as digital signal processing chips, graphics acceleration processors, and/or the like), a GNSS receiver 1350, memory 1340, DSP(s) 1320, a wireless transceiver 1330, a bus 1301, and antennas 1331 and 1351. In some embodiments, antennas 1331 and 1351 may be the same antenna. Furthermore, in addition to the wireless transceiver 1330, terrestrial wireless transceiver 1300 can further include a network interface (not shown) to communicate with a network (e.g., a network of a preferred carrier, Internet, etc.). Terrestrial wireless transceiver 1300 may be referred to as a Home NodeB (HNB) or Home eNode B (HeNB). Example terrestrial wireless transceivers 1300 may include access points (e.g. WiFi access points), femtocells, base stations, picocells, macrocells, Bluetooth™ transceivers, Zigbee™ transceivers or other suitable terrestrial wireless transceiver types.

The terrestrial wireless transceiver 1300 may further include (and/or be in communication with) one or more non-transitory storage devices (e.g., memory 1340), which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like. In various embodiments, functions may be stored as one or more instructions or code in memory 1340, such as on a computer-readable storage medium, such as RAM, ROM, FLASH, or disc drive, and executed by processor(s) 1310 or DSP(s) 1320. The terrestrial wireless transceiver 1300 can also comprise software elements (e.g., located within the memory 1340), including, for example, an operating system, device drivers, executable libraries, and/or other code, such as one or more application programs, which may comprise computer programs implementing the functions provided by various embodiments, and/or may be designed to implement methods and/or configure systems, as described herein.

In some embodiments, terrestrial wireless transceiver 1300 may be equipped with multiple antenna groups, not shown. The multiple antennas may facilitate communication with multiple mobile devices, such as mobile device 1216. In some embodiments, terrestrial wireless transceiver may communicate with preferred and non-preferred mobile devices.

FIG. 14 illustrates an example of a location server 1400, according to some embodiments. The location server 1400 may be configured to receive signal data measurements for a terrestrial wireless transceiver from a mobile device and to generate one or more heat maps for the terrestrial wireless transceiver, as described above. The location server 1400 may be configured to further provide feedback to the mobile device indicating that more signal data measurements may be needed to generate an accurate heat map, as described above.

The location server 1400 includes hardware elements that can be electrically coupled via a bus 1401 (or may otherwise be in communication, as appropriate). In one embodiment, the bus 1401 can be used for the processor 1410 to communicate between cores and/or with the memory 1440. The hardware elements may include one or more processors (e.g., processor 1410), including without limitation one or more general-purpose processors and/or one or more special-purpose processors (such as digital signal processing chips, graphics acceleration processors, and/or the like), GNSS receiver 1450, antenna 1451, a general-purpose processor(s) 1410, memory 1440, and a bus 1401. The location server 1400 may include a network interface (not shown) to communicate with a network. Location server 1400 may also include wireless transceiver 1430, which may enable server 1400 to transmit and receive signals wirelessly via antenna 1431. DSP 1420 may also be included and may be configured to process the wireless signals. In some embodiments, location server 1400 may be interconnected to other devices and/or networks through wired means, not shown.

The location server 1400 may further include (and/or be in communication with) one or more non-transitory storage devices (e.g., memory 1440), which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like. In various embodiments, functions may be stored as one or more instructions or code in memory 1440, such as on a computer-readable storage medium, such as RAM, ROM, FLASH, or disc drive, and executed by processor(s) 1410 or DSP(s) 1420. The location server 1400 can also comprise software elements (e.g., located within the memory 1440), including, for example, an operating system, device drivers, executable libraries, and/or other code, such as one or more application programs, which may comprise computer programs implementing the functions provided by various embodiments, and/or may be designed to implement methods and/or configure systems, as described herein.

As used herein, the terms “machine-readable medium,” “computer-readable medium,” or the like refer to any medium that participates in providing data that causes a machine to operate in a specific fashion. In an embodiment implemented using the mobile device 1216, terrestrial wireless transceiver 1300, and/or location server 1400, various computer-readable media might be involved in providing instructions/code to processor(s) 1211, 1310, and/or 1410 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include non-transitory media including, for example, optical and/or magnetic disks. Volatile media include non-transitory media including, for example, dynamic memory. Transmission media include, without limitation, coaxial cables, copper wire and fiber optics, including the wires that comprise the bus 1201, 1301, and/or 1401, as well as various components of a communications subsystem (and/or the media by which the communications subsystem provides communication with other devices). Hence, transmission media can also take the form of waves (including without limitation radio, acoustic and/or light waves, such as those generated during radio-wave and infrared data communications).

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media. Data storage media may be any available media that can be accessed by one or more computers or one or more processors to retrieve instructions, code and/or data structures for implementation of the techniques described in this disclosure. “Data storage media” as used herein refers to manufactures and does not refer to transitory propagating signals. By way of example, and not limitation, such computer-readable media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above may also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a mobile device, such as a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware stored on computer-readable media.

The foregoing description provides exemplary embodiments only, and is not intended to limit the scope, applicability, or configuration of the disclosure. Rather, the foregoing description of the example embodiments provide those skilled in the art with an enabling description for implementing the example embodiment. It should be understood that various changes may be made in the function and arrangement of elements without departing from the spirit and scope of the invention as set forth in the appended claims.

Specific details are given in the foregoing description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Various examples have been described. These and other examples are within the scope of the following claims.

What is claimed is:

1. A method, on a mobile device, of updating heat map data comprising:
obtaining, by the mobile device, first signal data for a terrestrial transceiver;
generating, by the mobile device, a transceiver heat map using the first signal data;
displaying, by the mobile device, a request to gather additional signal data for the terrestrial transceiver;
obtaining, by the mobile device, second signal data for the terrestrial transceiver;
generating, by the mobile device, an updated transceiver heat map using the second signal data; and
displaying, by the mobile device, the updated transceiver heat map.

2. The method of claim 1, further comprising:
determining a quality of the transceiver heat map;
comparing the quality to a predetermined quality threshold; and
displaying the request in response to the quality being below the predetermined quality threshold.

3. The method of claim 1, further comprising:
obtaining a transceiver heat map generation constraint;
determining a subset of the first signal data to use for generating the transceiver heat map based, at least in part, on the transceiver heat map generation constraint; and
generating the transceiver heat map using the subset of the first signal data.

4. The method of claim 3, wherein the transceiver heat map generation constraint includes a maximum time for generating the transceiver heat map.

5. The method of claim 4, further comprising:
determining an estimated time for generating the transceiver heat map;
comparing the maximum time to the estimated time; and
determining the subset of the first signal data to use for generating the transceiver heat map based on the comparison.

6. The method of claim 3, wherein the transceiver heat map generation constraint includes a maximum number of data points to use for generating the transceiver heat map, the data points including a plurality of signal strength measurements of the terrestrial transceiver.

7. The method of claim 6, wherein determining the subset of the first signal data includes determining a subset of the plurality of signal strength measurements to use for generating the transceiver heat map.

8. The method of claim 3, wherein the transceiver heat map generation constraint includes a maximum number of data points to use for generating the transceiver heat map, the data points including a plurality of feasible points of a venue.

9. The method of claim 8, wherein determining the subset of the first signal data includes determining a subset of the plurality of feasible points to use for generating the transceiver heat map.

10. The method of claim 9, further comprising using noise floor data for all points outside of the subset of the plurality of feasible points for generating the transceiver heat map.

11. The method of claim 1, wherein the transceiver heat map is updated as the second signal data is obtained.

12. An apparatus comprising:
memory;
a receiver configured to receive first signal data for a terrestrial transceiver;
one or more processors configured to generate a transceiver heat map using the first signal data; and
a display configured to display a request to gather additional signal data for the terrestrial transceiver;
wherein the receiver is configured to receive second signal data for the terrestrial transceiver; and
wherein the display is configured to display an updated transceiver heat map using the second signal data.

13. The apparatus of claim 12, further comprising:
wherein the one or more processors are configured to:
determine a quality of the transceiver heat map; and
compare the quality to a predetermined quality threshold; and
wherein the display is configured to display the request in response to the quality being below the predetermined quality threshold.

14. The apparatus of claim 12, wherein the one or more processors are further configured to:
obtain a transceiver heat map generation constraint;
determine a subset of the first signal data to use for generating the transceiver heat map based, at least in part, on the transceiver heat map generation constraint; and
generate the transceiver heat map using the subset of the first signal data.

15. The apparatus of claim 14, wherein the transceiver heat map generation constraint includes a maximum time for generating the transceiver heat map, and wherein the one or more processors are further configured to:
determine an estimated time for generating the transceiver heat map;
compare the maximum time to the estimated time; and
determine the subset of the first signal data to use for generating the transceiver heat map based on the comparison.

16. The apparatus of claim 14, wherein the transceiver heat map generation constraint includes a maximum number of data points to use for generating the transceiver heat map, the data points including a plurality of signal strength measurements of the terrestrial transceiver, and wherein determining the subset of the first signal data includes determining a subset of the plurality of signal strength measurements to use for generating the transceiver heat map.

17. The apparatus of claim 14, wherein the transceiver heat map generation constraint includes a maximum number of data points to use for generating the transceiver heat map, the data points including a plurality of feasible points of a venue, and wherein determining the subset of the first signal data includes determining a subset of the plurality of feasible points to use for generating the transceiver heat map.

18. One or more non-transitory computer-readable media storing computer-executable code executable on one or more computing devices included in a mobile device, comprising:
code to obtain first signal data for a terrestrial transceiver;
code to generate a transceiver heat map using the first signal data;
code to display a request to gather additional signal data for the terrestrial transceiver;
code to obtain second signal data for the terrestrial transceiver;
code to generate an updated transceiver heat map using the second signal data; and
code to display the updated transceiver heat map.

19. The one or more computer-readable media of claim 18, further comprising:
code to determine a quality of the transceiver heat map;
code to compare the quality to a predetermined quality threshold; and
code to display the request in response to the quality being below the predetermined quality threshold.

20. The one or more computer-readable media of claim 18, further comprising:
code to obtain a transceiver heat map generation constraint;
code to determine a subset of the first signal data to use for generating the transceiver heat map based, at least in part, on the transceiver heat map generation constraint; and
code to generate the transceiver heat map using the subset of the first signal data.
